(19) United States
(12) Patent Application Publication
(10) Pub. No.: US 2020/0033593 A1
(43) Pub. Date: Jan. 30, 2020

(54) CLEANING APPARATUS AND CONTROL METHOD FOR CLEANING APPARATUS

(71) Applicant: CANON KABUSHIKI KAISHA, Tokyo (JP)

(72) Inventors: Shoma Mizutani, Tokyo (JP); Kentaro Watanabe, Hachioji-shi (JP)

(21) Appl. No.: 16/521,343

(22) Filed: Jul. 24, 2019

(30) Foreign Application Priority Data
Jul. 30, 2018 (JP) 2018-142899
May 15, 2019 (JP) 2019-092467

(51) Int. Cl. G02B 27/00; B08B 6/00; B08B 5/02; B08B 1/00

(52) U.S. Cl. CPC G02B 27/0006; B08B 1/006; B08B 5/02; B08B 6/00

(57) ABSTRACT

A cleaning apparatus which cleans a detection element having a detection surface includes a wiping cleaner configured to perform wiping cleaning in a state of being in contact with the detection surface, and a conduction member configured to become conductive with the wiping cleaner to be made equal in electric potential to the wiping cleaner, wherein, when the wiping cleaner and the conduction member become conductive with each other, the detection surface and the wiping cleaner become equal in electric potential to each other.

### BACKGROUND OF THE INVENTION

### Field of the Invention

Aspects of the present disclosure generally relates to a cleaning apparatus which cleans the detection surface of a detection element that detects the physical amount of, for example, light or electromagnetic wave, and to a control method for the cleaning apparatus.

### Description of the Related Art

There are instances when dust adhering to the detection surface of a detection element which detects, for example, light or electromagnetic waves may cause false detection. For example, in the case of a digital camera including an image sensor in which photoelectric converters serving as light receiving elements are arranged side by side, periodically cleaning the imaging surface of the image sensor is helpful to prevent any decrease in the image quality of an image to be acquired. However, if the user cleans the imaging surface on their own, the user may damage the imaging surface by mistake. Thus, the user usually brings the digital camera into a maintenance service shop managed by, for example, a manufacturer thereof to request a professional worker therein to clean the imaging surface. Even with regard to professional workers, due to a difference in degree of proficiency, there are variations in work accuracy of cleanings. Therefore, Japanese Patent No. 4,537,105 discusses an apparatus which is able to be connected to a camera to clean the imaging surface of the camera by performing wiping with a wind pressure or an adhesive sheet.

However, Japanese Patent No. 4,537,105 does not address controlling the cleaning apparatus to remove dust present on the detection surface. Moreover, such cases addressed to remove dust adhering to the detection surface are not cases confined to image sensors, but are cases common to all types of detection elements including a detection surface to detect a physical amount, so that a cleaning apparatus is also expected to be provided therefor.

### SUMMARY OF THE INVENTION

Aspects of the present disclosure are generally directed to providing a cleaning apparatus which, with respect to a detection element having a detection surface, is capable of appropriately carrying out removal of dust adhering to the detection surface.

According to an aspect of the present disclosure, a cleaning apparatus which cleans a detection element having a detection surface includes a wiping cleaner configured to perform wiping cleaning in a state of being in contact with the detection surface, and a conduction member configured to become conductive with the wiping cleaner to be made equal in electric potential to the wiping cleaner, wherein, when the wiping cleaner and the conduction member become conductive with each other, the detection surface and the wiping cleaner become equal in electric potential to each other.

According to another aspect of the present disclosure, a cleaning apparatus which cleans a detection element having a detection surface includes a wiping tool configured to clean the detection surface while being in contact with the detection surface, a take-up mechanism configured to take up the wiping tool, a core material configured to fold back the wiping tool in a take-up direction and bring a folded-back portion of the wiping tool into contact with the detection surface, and a guide member configured to regulate motion of the wiping tool at the folded-back portion of the wiping tool, wherein the guide member includes a take-up port on a take-up side with respect to the core material, and an opening width of the take-up port of the guide member is formed to be narrower than a width of the wiping tool.

Further features of the present disclosure will become apparent from the following description of exemplary embodiments with reference to the attached drawings.

### BRIEF DESCRIPTION OF THE DRAWINGS

FIGS. 1A, 1B, and 1C are an appearance perspective view, an internal structure front view, and an internal structure back view, respectively, of a cleaning apparatus according to an exemplary embodiment of the present disclosure.

FIG. 2 is a front view of an imaging apparatus according to the present exemplary embodiment.

FIG. 3 is a block diagram illustrating principal components of the cleaning apparatus and the imaging apparatus according to the present exemplary embodiment.

FIGS. 4A, 4B, and 4C are flowcharts illustrating respective sequences of the cleaning apparatus according to the present exemplary embodiment.

FIG. 5 is a flowchart illustrating a series of cleaning sequences according to the present exemplary embodiment.

FIGS. 6A and 6B are diagrams of an image sensor in a first cleaning sequence according to the present exemplary embodiment.

FIGS. 7A, 7B, and 7C are diagrams of the image sensor in a second cleaning sequence according to the present exemplary embodiment.

FIG. 8 is an appearance diagram of a second cleaning unit according to the present exemplary embodiment.

FIGS. 9A, 9B, and 9C are diagrams illustrating a configuration of a fore-end region of the second cleaning unit according to the present exemplary embodiment.

FIG. 10 is a front view illustrating the configuration of the fore-end region of the second cleaning unit according to the present exemplary embodiment.

FIGS. 11A and 11B are a bird's-eye view and a sectional view, respectively, illustrating the configuration of the fore-end region of the second cleaning unit according to the present exemplary embodiment.

FIGS. 12A and 12B are side views illustrating contact angles which are used when the second cleaning unit according to the present exemplary embodiment cleans the surface of the image sensor.

FIG. 13 is a diagram of the image sensor used to explain a cleaning method which the second cleaning unit according to a first modification example of the present exemplary embodiment uses.

FIGS. 14A, 14B, 14C, and 14D are diagrams of the image sensor used to explain the cleaning method which the second cleaning unit according to the first modification example of the present exemplary embodiment uses.

FIG. 15 is a diagram of the image sensor used to explain a cleaning method which the second cleaning unit according to a second modification example of the present exemplary embodiment uses.

FIG. 16 is a diagram of the image sensor used to explain the cleaning method which the second cleaning unit according to the first modification example of the present exemplary embodiment uses.

FIG. 17 is an appearance diagram of a second cleaning unit according to a third modification example of the present exemplary embodiment.

FIGS. 18A, 18B, and 18C are side views illustrating an operation which the second cleaning unit according to the third modification example of the present exemplary embodiment performs when cleaning the surface of the image sensor.

FIGS. 19A, 19B, 19C, 19D, 19E, 19F, 19G, 19H, and 19I are side views illustrating an operation which the second cleaning unit according to the third modification example of the present exemplary embodiment performs when cleaning the surface of the image sensor.

FIG. 20 is a side view illustrating an operation which the second cleaning unit according to the third modification example of the present exemplary embodiment performs when cleaning the surface of the image sensor.

### DESCRIPTION OF THE EMBODIMENTS

Various exemplary embodiments, features, and aspects of the disclosure will be described in detail below with reference to the accompanying drawings. Furthermore, components and portions in common in the illustrated figures are assigned the respective same reference characters.

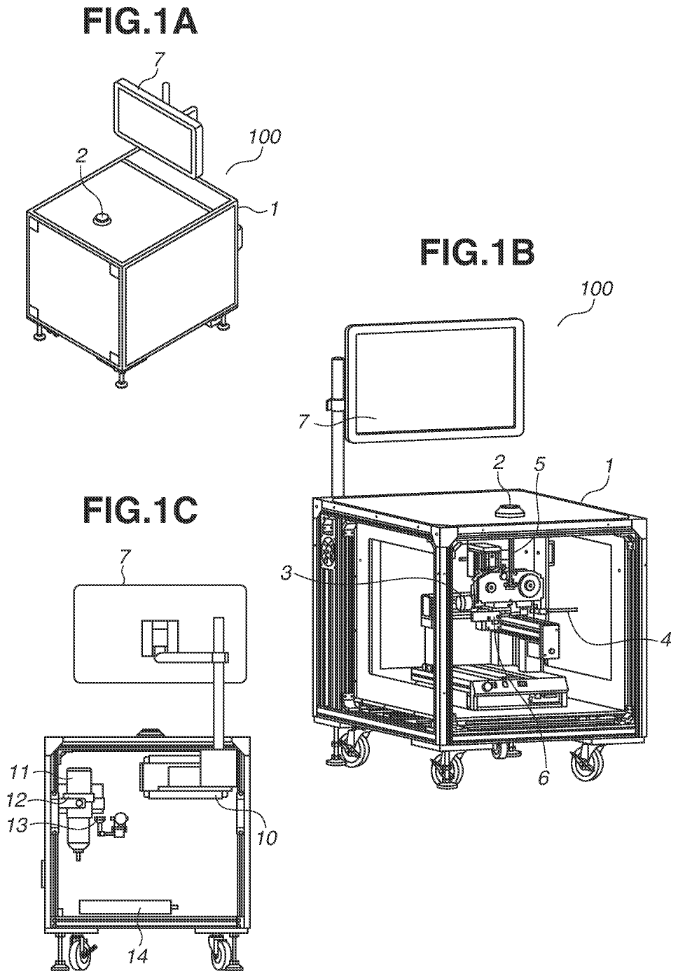

FIGS. 1A, 1B, and IC illustrate a cleaning apparatus 100 as an example of a cleaning apparatus according to an exemplary embodiment of the present disclosure. In the present exemplary embodiment, a cleaning apparatus which cleans the imaging surface of an image sensor configured with, for example, a complementary metal-oxide semiconductor (CMOS) sensor included in a digital camera is described as an example.

FIG. 1A is an appearance diagram of the cleaning apparatus 100. The cleaning apparatus 100 includes a main body 1, which is made of a metallic chassis, a fixing unit 2, which fixes a detection apparatus serving as a cleaning target (in the present exemplary embodiment, a camera), and a display unit 7, which displays various pieces of information. The display unit 7 can be configured as a separate unit which is capable of communicating with the cleaning apparatus 100.

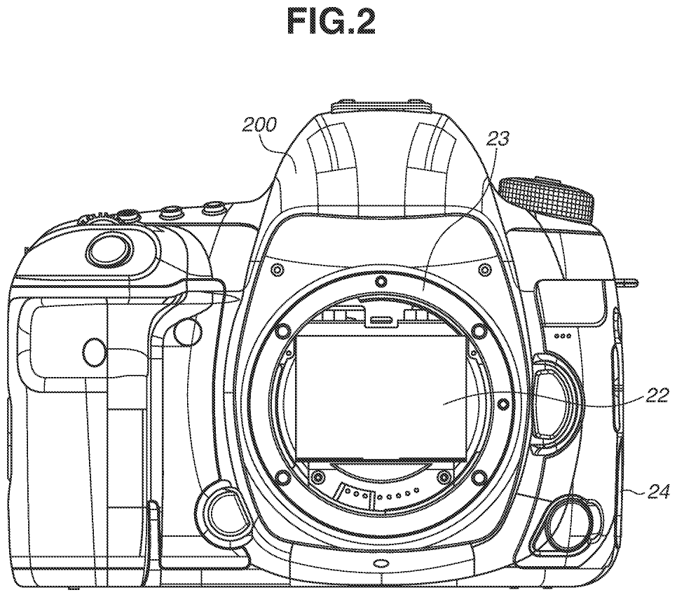

FIG. 1B is a diagram illustrating an internal configuration of the cleaning apparatus 100. A movable seat 6 is integrally equipped with a confirmation unit 3, a first cleaning unit 4, and a second cleaning unit 5, and the movable seat 6 is able to perform translation and rotation in three-dimensional directions so as to change the positions of the respective units as appropriate. In particular, the movable seat 6 includes a translational mechanism, which is able to perform translational motion along the vertical direction, in such a manner that the respective units are able to come close to and retract from the position of the fixing unit 2, in other words, the surface of the image sensor (detection surface) included in a camera 200 (FIG. 2) attached to the cleaning apparatus 100.

The fixing unit 2 is made of a ring-shaped metallic member located on the exterior surface of the main body 1, and in the present exemplary embodiment, has a structure to which a camera mount, which is used for a camera to allow an interchangeable lens to be attached to and detached from the camera during normal use, is able to be attached and fixed. The fixing unit 2 includes an electrical connection terminal and is thus able to communicate with the camera attached thereto. Moreover, the fixing unit 2 includes a ring-shaped illumination lamp to secure the amount of light used to monitor the behavior of cleaning performed by the cleaning apparatus 100, and thus radiates light to a detection element serving as a cleaning target (an image sensor of the camera) during cleaning of the detection element performed by the first cleaning unit 4 and the second cleaning unit 5. Moreover, since the appropriate shape (mechanism) of a connection portion of the fixing unit 2 particularly varies depending on the type of an external apparatus to be attached to the fixing unit 2, the fixing unit 2 can be configured to be attachable to and detachable from the main body 1 and can be replaced with another type of fixing unit in conformity with an external apparatus supposed to be connected thereto, or various types of fixing units can be provided as much as the number of types of external apparatuses supposed to be connected thereto. Additionally, the fixing unit 2 can be provided as a general-purpose fixing mechanism which is capable of fixing cameras irrespective of the types of cameras.

In the present exemplary embodiment, the cleaning apparatus 100 detects attachment of the camera with use of a connection terminal included in what is called a camera mount of the camera serving as a target for attachment. In other words, the cleaning apparatus 100 detects that the camera has been attached to the cleaning apparatus 100, based on a connection terminal of the fixing unit 2 having been electrically connected to the connection terminal of the camera mount.

The first cleaning unit 4 is a cleaning instrument which performs non-contact-type cleaning on the surface of a detection element, and, in the present exemplary embodiment, blows air, thus blowing off dust by wind pressure.

The second cleaning unit 5 is a cleaning instrument which performs contact-type cleaning on the surface of a detection element, and, in the present exemplary embodiment, catches dust by performing wiping cleaning using a wiping tool.

FIG. 1C is a diagram illustrating a configuration of the back surface of the cleaning apparatus 100. A control unit 10 is configured with a computer including a central processing unit (CPU), and performs operation control of the entire cleaning apparatus 100, thus processing pieces of information received from various units and issuing instructions to various units.

An air filter 11 is a filter which, when air to be used for the first cleaning unit 4 is injected from, for example, an external pump via an intake port 12, reduces dust or oil content present in the air, and the air having passed through the filter is supplied to the first cleaning unit 4. If there is no air filter 11, dust included in air may be blown onto the detection surface of a detection element. A pressure gauge 13 measures the pressure of air to be injected and displays the measured pressure. The user can watch the pressure indicated by the pressure gauge 13 and adjust the pressure of air to an appropriate pressure as needed.

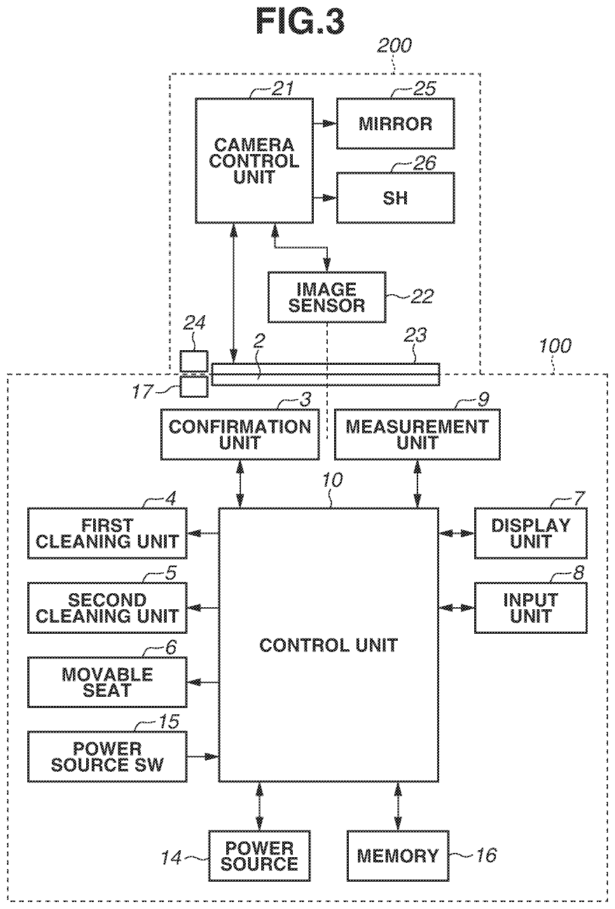

A power source 14 supplies electric power to the entire cleaning apparatus 100. Moreover, the power source 14 can be configured to include the function of supplying electric power to an external apparatus via an interface (in the present exemplary embodiment, for example, the electrical connection terminal of the fixing unit 2 or a communication unit 17 (FIG. 3).

FIG. 2 illustrates a camera 200, which is an example of an apparatus including an image sensor being a detection element serving as a cleaning target. In the present exemplary embodiment, the camera 200 is a lens-interchangeable single-lens reflex digital camera. A camera communication unit 24 performs communication with an external apparatus fixed to and electrically connected to the camera 200 at a camera fixing unit 23. In a case where the external apparatus is a lens, a camera control unit (not illustrated) performs lens control and exchanges various pieces of information about the lens and the camera 200. An image sensor 22 receives subject light and converts the subject light into an electrical signal, thus generating digital image data. While, in the present exemplary embodiment, a CMOS sensor is used as the image sensor 22, besides, various types of image sensors, such as a charge-coupled device (CCD) type and a charge injection device (CID) type, can be used. Additionally, the detection element is not limited to a light receiving element, but any form of detection element can be used as a cleaning target for the cleaning apparatus 100 as long as the detection element has a function of performing detection at the surface of the detection element, such as a detection element which detects electromagnetic waves such as X-rays. Moreover, the image sensor 22 has a structure in which, for example, a cover glass, an infrared (IR) cut filter, and a low-pass filter (LPF) are superposed on photo diodes along the thickness direction, and the cleaning apparatus 100 treats the frontmost surface of the image sensor 22 as a cleaning target.

The image sensor 22 has a configuration in which, to prevent the image sensor 22 from being electrically charged with static electricity, the surface of the image sensor 22 is connected in such a way as to become at the same potential as that of the camera 200, and the camera fixing unit 23 is also connected in such a way as to become at the same potential as that of the camera 200.

Next, a connection configuration between the cleaning apparatus 100 according to the present exemplary embodiment and the camera 200, which is a detection apparatus according to the present exemplary embodiment, is described with reference to FIG. 1B and FIG. 2.

The camera 200 is fixed by the camera fixing unit 23 being connected to the fixing unit 2 of the cleaning apparatus 100. The control unit 10 is able to control the camera 200 by performing communication with a camera control unit 21 (FIG. 3) via the communication unit 17 and the camera communication unit 24, which are described below. For example, the cleaning apparatus 100 is able to determine the type of the camera 200 and perform control of, for example, an image capturing operation for moving a mirror and a shutter in the camera 200.

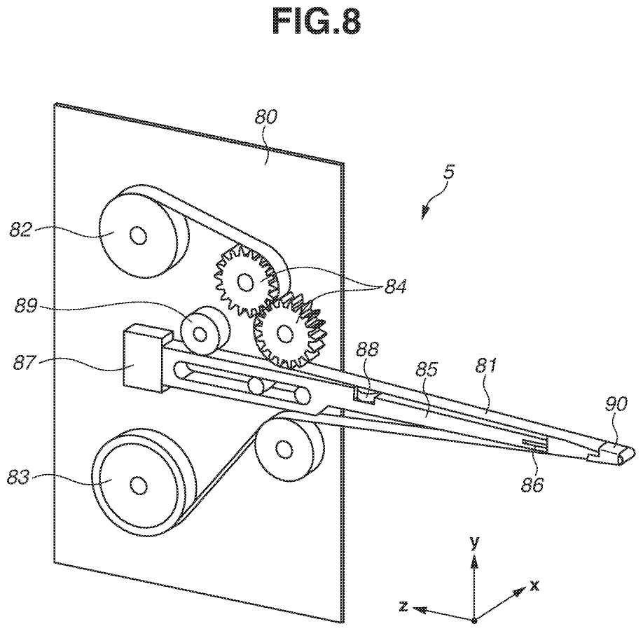

Moreover, a range from the camera 200 to a fore-end core portion 86 (FIG. 8) of the second cleaning unit 5 is made conductive via the camera fixing unit 23. This prevents the occurrence of a potential difference between the image sensor 22 and the second cleaning unit 5, and thus enables performing cleaning without the removed dust being attracted to the camera 200 by electrostatic force.

In FIG. 1B, the second cleaning unit 5 is set to face in the direction of the fixing unit 2. Since the movable seat 6 has a translational mechanism for upward and downward translational movement, the second cleaning unit 5 is able to pass through the ring center of the fixing unit 2 and come close to the image sensor 22 with the camera 200 physically connected to the cleaning apparatus 100.

Moreover, the movable seat 6 also has a rotational mechanism which rotates an attached member, and the confirmation unit 3, the first cleaning unit 4, and the second cleaning unit 5 are located at respective positions with different phases around the rotation axis of the rotational mechanism. The rotational mechanism enables rotationally driving the confirmation unit 3 and the first cleaning unit 4 to the respective positions in which the front sides of the respective units face the fixing unit 2 (in other words, the imaging surface of the image sensor 22), as with the second cleaning unit 5.

Moreover, the rotational mechanism of the movable seat 6 is also used to control the inclination (angle) of a cleaning portion of each cleaning unit relative to the detection surface in a cleaning sequence for each cleaning unit described below. More specifically, according to control performed by the control unit 10, the rotational mechanism of the movable seat 6 is used to control the inclination of a blowing port when the first cleaning unit 4 blows air to the detection surface of the image sensor 22 and is used to control the inclination of a wiping tool (and a core material) when the second cleaning unit 5 performs wiping cleaning on the detection surface. As mentioned above, the translational mechanism and the rotational mechanism of the movable seat 6 enable the control unit 10 to control the distance of each unit to the detection surface, such as to cause each unit to face, come close to, and retract from the fixing unit 2, in other words, the detection surface of the detection element.

The confirmation unit 3 includes an illumination lamp, and radiates illumination light onto a target according to an instruction from the control unit 10. In the present exemplary embodiment, a light-emitting diode (LED), which is mounted on the fore-end of the confirmation unit 3, radiates light onto the image sensor 22 with the confirmation unit 3 being in proximity to the image sensor 22, and the image of the imaging surface (sensor surface) of the image sensor 22 is captured to acquire an image used to confirm any state of dirt of the sensor surface. While, in the exemplary embodiment described below, the image capturing function of the image sensor 22 is used to acquire an image of the sensor surface, the present disclosure is not limited to this, and the confirmation unit 3 itself can be configured to include some sort of sensor, such as an image sensor, and, thus, to be able to acquire information usable to confirm the state of the detection element surface. Moreover, while, in the present exemplary embodiment, the confirmation unit 3 is mounted on the movable seat 6 together with the first cleaning unit 4 and the second cleaning unit 5, for example, the confirmation unit 3 can be located while being fixed to, for example, the vicinity of the fixing unit 2. In such a location, the confirmation unit 3 is able to perform radiation of light and image capturing even during execution of cleaning by each cleaning unit. Moreover, an illumination unit and/or an image sensor can be provided as the confirmation unit 3 in the vicinity of each of the cleaning members (a blowing port and a wiping tool at the fore-end of the core material) of the first cleaning unit 4 and the second cleaning unit 5.

The first cleaning unit 4 is a cleaning instrument which performs non-contact-type cleaning on the detection element surface, and, in the present exemplary embodiment, blows air from the fore-end (blowing port) of a tubular member, thus blowing off, by wind pressure, dust adhering to the surface of the image sensor 22 located near the first cleaning unit 4. Additionally, in the present exemplary embodiment, to remove static electricity of dust adhering to the surface of the image sensor 22 so as to easily detach the dust from the surface of the image sensor 22, the first cleaning unit 4 includes an ionizer which electrically charges air to provide a static electricity removal function. However, since even only blowing of air, without such a static electricity removal function, has a certain degree of effect, the ionizer is not necessarily needed.

The second cleaning unit 5 is a cleaning instrument which performs contact-type cleaning on the detection element surface, and, in the present exemplary embodiment, catches dust by directly wiping the surface of the image sensor 22 located near the second cleaning unit 5 with wiping cleaning using a wiping tool principally attached to the fore-end of the core material. The wiping tool is made of, for example, microfiber cloth, paper, or tape and is configured to be of the take-up type, in which, as the second cleaning unit 5 performs wiping cleaning using contact and movement, a new wiping tool comes into contact with the cleaning surface. Additionally, in the present exemplary embodiment, as needed, the second cleaning unit 5 is also configured to be able to perform cleaning with a solvent for cutting greasy dirt applied to the wiping tool. With regard to the first cleaning unit 4 and the second cleaning unit 5, the respective specific configurations thereof are not particularly limited as long as those are a non-contact-type cleaning instrument and a contact-type cleaning instrument, respectively.

FIG. 3 is a block diagram illustrating principal electrical configurations of the cleaning apparatus 100 and the camera 200 according to the present exemplary embodiment.

The cleaning apparatus 100 operates with electric power supplied from the power source 14, and turning-on and turning-off of the power source 14 are switched by a power source switch (SW) 15. The display unit 7 displays various pieces of information according to instructions from the control unit 10, such as various pieces of information about the cleaning apparatus 100 and the camera 200, statuses of operations, settings performed by the user operation, and guidance for the user operation.

An input unit 8 receives information about an external apparatus stored in a memory 16 or acquired via the communication unit 17 or another communication pathway, to enable performing an appropriate operation according to a camera to be attached. Moreover, the input unit 8 also receives various pieces of instruction information issued by the user operation. In the present exemplary embodiment, the cleaning apparatus 100 is assumed to acquire, via the input unit 8, information about the model and specifications of the camera 200 to be connected as information about an external apparatus.

A measurement unit 9 is configured with, for example, a laser distance meter, and measures the position (for example, the coordinates and the distance to the image sensor) and size of the image sensor 22 included in the camera 200 connected to the cleaning apparatus 100. In the case of a situation in which model information about the camera to be attached is determined and a cleaning program corresponding to the determined model information is previously stored in the memory 16, the measurement unit 9 does not necessarily need to be provided to measure the position and size of the camera. The control unit 10, which is configured with a computer including a CPU incorporated in the main body 1 of the cleaning apparatus 100, performs operation control of the cleaning apparatus 100, thus processing pieces of information received from various units and issuing instructions to various units.

The connection terminal provided at the fixing unit 2 is electrically connected to the connection terminal of the camera mount when the camera fixing unit 23 is attached to the fixing unit 2, so that the control unit 10 detects connection of the camera 200.

The communication unit 17 performs communication with a detection apparatus including a detection element. In the present exemplary embodiment, the communication unit 17 includes a connection terminal compliant with the standard of Universal Serial Bus (USB), and is configured to be electrically connected to the camera communication unit 24 included in the camera 200 via a connection cable. When the connection cable is connected to the respective terminals of the communication unit 17 and the camera communication unit 24 with both the cleaning apparatus 100 and the camera 200 powered on, energization is performed and communication is established. The communication method used for the cleaning apparatus 100 and the camera 200 is not limited to this, but can be any one of applicable known communication methods, such as wired local area network (LAN), High-Definition Multimedia Interface (HDMI®), and wireless LAN (Wi-Fi, Bluetooth®, and Bluetooth Low Energy (BLE)).

Next, a configuration example of the camera 200, which is detachably connected to the cleaning apparatus 100, is described. The camera control unit 21 is a microcomputer, and performs control of the entire camera 200, such as operation control of the image sensor 22 and storing and data communication of a captured image.

The image sensor 22 is located at a position which is able to be accessed from an opening portion in which the camera mount is provided, and includes a detection surface configured with photo diodes for receiving a light flux from a subject with an image capturing lens usually attached to the camera 200. The image sensor 22 converts the received light flux into an electrical signal, thus outputting image data.

A mirror 25 is located on the optical axis of the camera 200 on the subject side of the image sensor 22, and reflects or separates light, which goes to the image sensor 22, to, for example, a sensor (not illustrated) other than the image sensor 22 or an optical viewfinder. During cleaning of the image sensor 22, the mirror 25 needs to be retracted to no small extent from on the optical axis of the image sensor 22. In the present exemplary embodiment, a mechanism in the camera 200 for retracting the mirror 25 from on the optical axis during exposure on the image sensor 22 is assumed to be used to retract the mirror 25 from on the optical axis to such a degree that a member from the cleaning apparatus 100 is able to come close to the image sensor 22 during cleaning. While, in the present exemplary embodiment, the camera 200, which is a detection apparatus, is a single-lens reflex digital camera having the mirror 25, the present disclosure can also be applied to what is called a mirrorless single-lens camera, which does not have an optical viewfinder or an optical mirror.

A light blocking member 26 is located on the subject side of the image sensor 22 in the camera 200, and serves as a shutter which blocks light from falling on the image sensor 22 during image capturing.

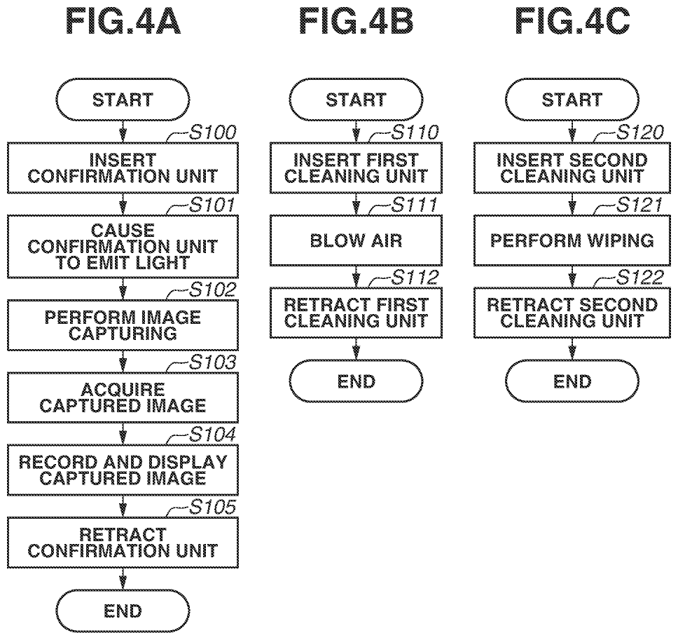

Next, various operation sequences of the cleaning apparatus 100 are described with reference to FIGS. 4A, 4B, and 4C.

FIG. 4A is a flowchart illustrating a confirmation sequence for confirming the state (the state of dirt or the cleaned state) of the detection element surface, which is a cleaning target, with use of the confirmation unit 3. The control unit 10 performs operations or issues instructions for operations to various units in the present flow as appropriate in the entire cleaning process which the cleaning apparatus 100 performs. In the stage in which the cleaning apparatus 100 starts the confirmation sequence, the camera 200 is previously fixed to the cleaning apparatus 100 by the camera fixing unit 23 and the fixing unit 2, and communication is previously established between the cleaning apparatus 100 and the camera 200 via the camera communication unit 24 and the communication unit of the fixing unit 2.

First, in step S100, the control unit 10 controls the movable seat 6 to cause the confirmation unit 3 to face in the direction of the fixing unit 2 and then to move the confirmation unit 3 in such a way as to pass through the fixing unit 2 and the camera fixing unit 23, thus bringing the fore-end of the confirmation unit 3 close to the image sensor 22. In step S101, the control unit 10 causes the confirmation unit 3 to irradiate the image sensor 22 with light emitted from a point light source, such as an LED, mounted on the fore-end of the confirmation unit 3 in the vicinity of the image sensor 22. While the form of illumination is not limited to a point light source but can be any form, since a point light source enables uniform light to be easily incident on each light receiving element, it is possible to measure the state of the detection surface almost in the same condition, so that a point light source is favorable.

In step S102, in the state in which the above-mentioned illumination is being performed, the control unit 10 sends a signal to the camera control unit 21 via the communication unit 17 and the camera communication unit 24, thus causing the image sensor 22 to perform an image capturing operation, and, then in step S103, the image sensor 22 acquires a captured image. In step S104, the control unit 10 records the acquired captured image on the memory 16 via the communication unit 17, and converts the acquired captured image into a display image and then displays the display image on the display unit 7. At this time, the control unit 10 detects the state of the image sensor surface and information about dust and dirt from the captured and recorded image by, for example, known image analysis, such as singularity detection, and then displays such pieces of information together with the captured image on the display unit 7. In the present exemplary embodiment, the control unit 10 further performs, for example, confirmation of the initial state of the imaging surface, determination of completion of cleaning after the end of cleaning, and presentation of a comparison between surface states obtained before and after cleaning, based on the detected pieces of information. In the present exemplary embodiment, in the confirmation sequence after any cleaning, the control unit 10 performs presentation of a comparison between surface states obtained before and after cleaning on the display unit 7, thus being able to let the user know the effect of cleaning and any remaining dust. In step S105, after image recording, the control unit 10 retracts the confirmation unit 3 from the vicinity of the image sensor 22, and then the confirmation sequence ends.

FIG. 4B is a flowchart illustrating a first cleaning sequence for cleaning the detection element surface by a non-contact-type cleaning method with use of the first cleaning unit 4. The control unit 10 performs operations or issues instructions for operations to various units in the present flow as appropriate in the entire cleaning process which the cleaning apparatus 100 performs. In the stage in which the cleaning apparatus 100 starts the first cleaning sequence, the camera 200 is previously fixed to the cleaning apparatus 100 by the camera fixing unit 23 and the fixing unit 2, and communication is previously established between the cleaning apparatus 100 and the camera 200 via the camera communication unit 24 and the communication unit 17.

First, in step S110, the control unit 10 controls the movable seat 6 to cause the first cleaning unit 4 to face in the direction of the fixing unit 2 and then to move the first cleaning unit 4 in such a way as to pass through the fixing unit 2 and the camera fixing unit 23, thus bringing a portion used for cleaning (fore-end) included in the first cleaning unit 4 close to the image sensor 22. After that, in step S111, the control unit 10 causes the first cleaning unit 4 to blow air from the blowing port at the fore-end thereof in the vicinity of the image sensor 22.

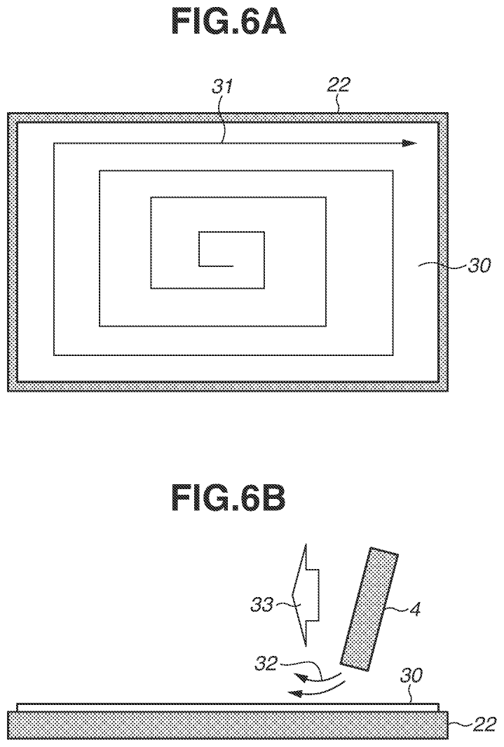

FIGS. 6A and 6B are imagery diagrams illustrating a cleaning method performed by the first cleaning unit 4 in step S111. FIG. 6A is a diagram illustrating the image sensor surface 30 of the image sensor 22 as viewed from the front side thereof, and FIG. 6B is a diagram illustrating the image sensor surface 30 of the image sensor 22 as viewed from the lateral side thereof and also illustrating a behavior in which the first cleaning unit 4 is coming close to the image sensor surface 30 and is blowing air.

As illustrated in FIG. 6A, the control unit 10 causes the first cleaning unit 4 to blow air while controlling the movable seat 6 to move the first cleaning unit 4 as in a movement trajectory 31 relative to the surface 30 of the image sensor 22. Moreover, as illustrated in FIG. 6B, the first cleaning unit 4 in the process of being moved is controlled in such a manner as to blow air in the direction parallel to the advancing direction 33 thereof. The movement trajectory 31 is set in the form of spreading outward in such a way as to draw a spiral from the central portion of the image sensor 22. Employing such a trajectory enables blowing off dust adhering to the image sensor surface 30 to outside the image sensor 22, and also enables preventing or reducing the dust once blown off from adhering to the image sensor surface 30 again. Moreover, moving the first cleaning unit 4 with the first cleaning unit 4 inclined in such a way as to blow air in the same direction as the advancing direction 33 enables attaining an advantageous effect of discharging the blown-off dust to outside the image sensor 22 to a greater extent and also enables causing the first cleaning unit 4 to operate while avoiding the light-blocking member located near the end portion of the image sensor surface 30.

In this way, the first cleaning unit 4 is able to remove dust, such as relatively-large solid refuse or mote, adhering to the image sensor surface 30 of the image sensor 22 with use of blown air. Here, if, for example, in a state in which large solid refuse adheres to the image sensor surface 30, the cleaning apparatus 100 performs cleaning in such a way as to wipe the image sensor surface 30 just like the second cleaning unit 5 does, the image sensor surface 30 may be damaged by the dust being dragged. On the other hand, the method of removing dust in a non-contact manner just like the first cleaning unit 4 does has an advantageous effect of not dragging dust on the image sensor surface 30 and thus of being unlikely to damage the image sensor surface 30.

Moreover, in the present exemplary embodiment, throughout the first cleaning sequence, the control unit 10 controls the movable seat 6 in such a manner that the first cleaning unit 4 does not come into contact with the image sensor surface 30 of the image sensor 22. This enables further reducing the possibility of damaging the image sensor surface 30 of the image sensor 22. In step S112, after blowing of air, the control unit 10 retracts the first cleaning unit 4 from the vicinity of the image sensor 22, and then the first cleaning sequence ends.

FIG. 4C is a flowchart illustrating a second cleaning sequence for performing non-contact-type cleaning on the surface of the detection element with use of the second cleaning unit 5. The control unit 10 performs operations or issues instructions for operations to various units in the present flow as appropriate in the entire cleaning process which the cleaning apparatus 100 performs. In the stage in which the cleaning apparatus 100 starts the second cleaning sequence, the camera 200 is previously fixed to the cleaning apparatus 100 by the camera fixing unit 23 and the fixing unit 2, and communication is previously established between the cleaning apparatus 100 and the camera 200 via the camera communication unit 24 and the communication unit of the fixing unit 2.

First, in step S120, the control unit 10 controls the movable seat 6 to cause the second cleaning unit 5 to face in the direction of the fixing unit 2 and then to move the second cleaning unit 5 in such a way as to pass through the fixing unit 2 and the camera fixing unit 23, thus bringing a portion used for cleaning (fore-end) included in the second cleaning unit 5 close to the image sensor 22. Here, in the case of using a solvent for removing, for example, greasy dirt during wiping cleaning, the control unit 10 controls the movable seat 6 to dip the fore-end of the second cleaning unit 5 into a container containing the solvent provided at another rotational position, and then to cause the second cleaning unit 5 to face in the direction of the fixing unit 2. After that, in step S121, the control unit 10 brings the fore-end of the second cleaning unit 5 into contact with the image sensor 22 in the vicinity of the image sensor 22, thus wiping the surface of the image sensor 22 with a wiping tool (for example, cloth or paper) attached to the fore-end of the second cleaning unit 5.

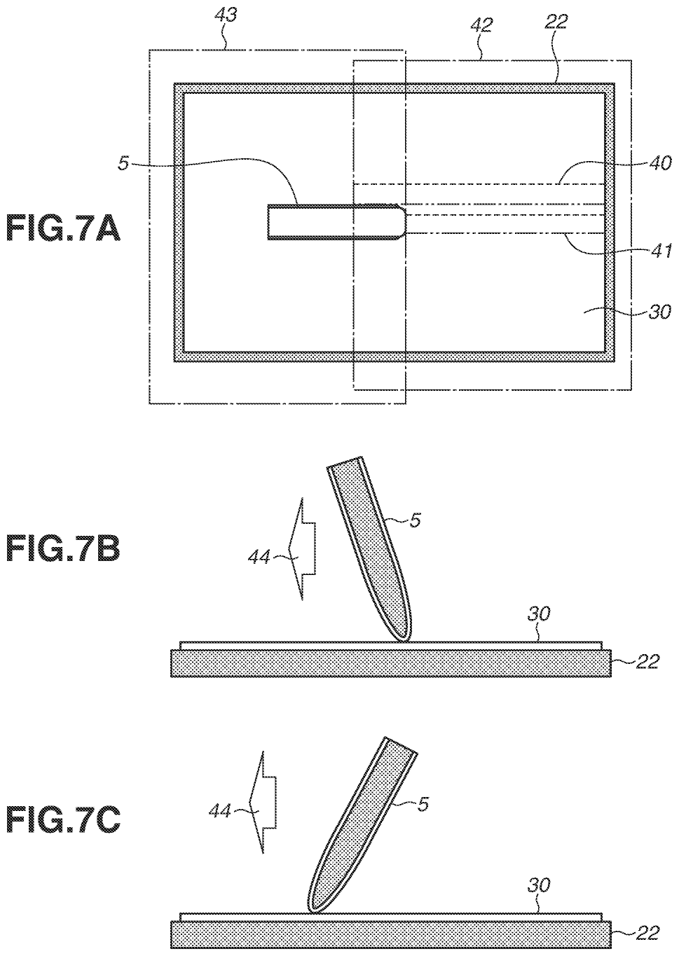

FIGS. 7A, 7B, and 7C are imagery diagrams illustrating a cleaning method performed by the second cleaning unit 5 in step S121. FIG. 7A is a diagram illustrating the image sensor surface 30 of the image sensor 22 as viewed from the front side thereof, and FIG. 7B is a diagram illustrating the image sensor surface 30 of the image sensor 22 as viewed from the lateral side thereof and also illustrating a behavior in which the second cleaning unit 5 is in contact with the image sensor surface 30 and is wiping the image sensor surface 30 with the wiping tool attached to the fore-end of the second cleaning unit 5.

As illustrated in FIG. 7A, the control unit 10 causes the second cleaning unit 5 to perform wiping cleaning with the wiping tool attached to the fore-end thereof while controlling the movable seat 6 to move the second cleaning unit 5 relative to the surface 30 of the image sensor 22. The second cleaning unit 5 performs wiping cleaning in a sequential scanning manner while partially overlapping cleaning regions as in a first movement trajectory 40 and a second movement trajectory 41 as illustrated in FIG. 7A. Additionally, the second cleaning unit 5 partially overlaps a first cleaning area 42 and a second cleaning area 43, thus preventing incomplete wiping. Moreover, in each cleaning area, to prevent incomplete wiping and throw off dust to outside the image sensor surface 30, basically, it is desirable that the second cleaning unit 5 perform wiping in the same direction. FIG. 7B illustrates a behavior in which the second cleaning unit 5 is performing wiping cleaning in a cleaning direction 44 within the first cleaning area 42. At this time, the second cleaning unit 5 comes into contact with the image sensor surface 30 while inclining in the same direction as the cleaning direction 44 from the plane perpendicular to the cleaning direction 44. FIG. 7C illustrates a behavior in which the second cleaning unit 5 is performing wiping cleaning in the cleaning direction 44 within the second cleaning area 43. At this time, the second cleaning unit 5 comes into contact with the image sensor surface 30 while inclining in the direction opposite to the cleaning direction 44 from the plane perpendicular to the cleaning direction 44. Moreover, when the second cleaning unit 5 moves from the first movement trajectory 40 to the second movement trajectory 41 or when the second cleaning unit 5 moves from the first cleaning area 42 to the second cleaning area 43, the control unit 10 causes the second cleaning unit 5 to once move away from the image sensor surface 30 and then move to the next cleaning start position. In other words, after causing the second cleaning unit 5 to move away from the image sensor surface 30 at the end position of the last movement trajectory within the first cleaning area 42, the control unit 10 causes the second cleaning unit 5 to move to the next cleaning start position. Moreover, in a case where pixels at the end portion of the image sensor surface 30 are hidden by, for example, the light-blocking member, performing scanning with the second cleaning unit 5 inclined as illustrated in FIG. 7B enables performing wiping cleaning to every edge of the image sensor surface 30 without the second cleaning unit 5 coming into contact with, for example, the light-blocking member.

With the above-mentioned procedure performed, the second cleaning unit 5 is able to remove, from the surface of the image sensor 22, dust or dirt of, for example, high-tackiness oil adhering to the surface of the image sensor 22. In step S122, after completion of cleaning, the control unit 10 retracts the second cleaning unit 5 from the vicinity of the image sensor 22, and then the second cleaning sequence ends.

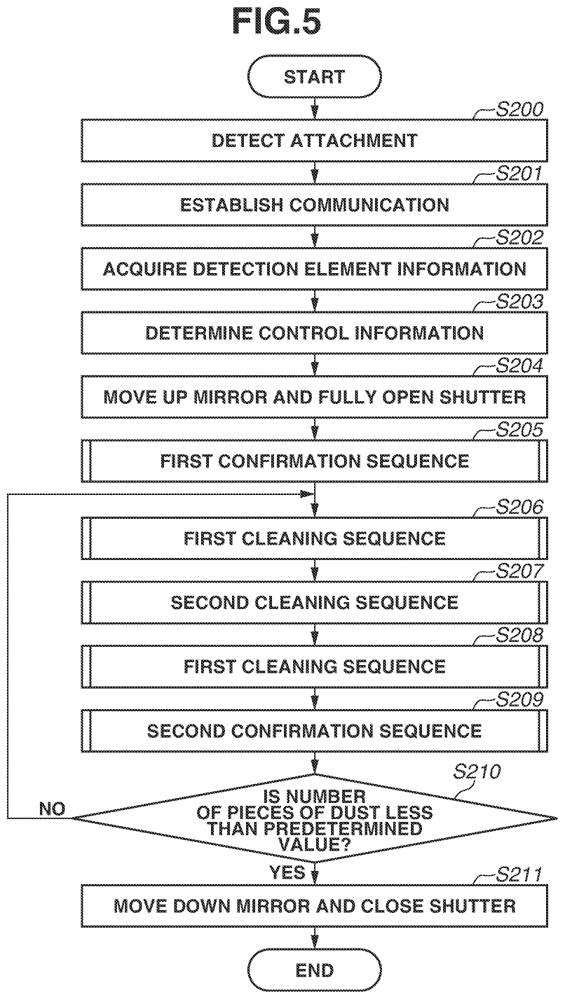

Next, the flow of the entire cleaning process according to the present exemplary embodiment is described with reference to the flowchart of FIG. 5. The present flow starts, for example, in response to the power source 14 being turned on by the power source SW 15 being operated or in response to a start instruction for the cleaning process being received from the input unit 8. In the present flow, the control unit 10 performs various operations or issues instructions for various operations to various units.

In step S200, the control unit 10 detects that the camera fixing unit 23 of the camera 200 has been attached and fixed to the fixing unit 2, based on the connection terminal provided in the fixing unit 2. Next, in step S201, the control unit 10 detects that the communication unit 17 and the camera communication unit 24 have been electrically connected to each other and, in response to such connection being used as a trigger, establishes communication between the cleaning apparatus 100 and the camera 200.

Next, in step S202, the control unit 10 acquires detection element information about a detection element serving as a cleaning target. The control unit 10 acquires, as the detection element information, for example, information about the position, size, and material of the image sensor 22 and information about, for example, the position of a member which obstructs cleaning of the image sensor 22. The control unit 10 can acquire these pieces of information from the camera 200 via communication, or can read out the detection element information from a database previously stored in the memory 16 based on camera model information acquired from the camera 200. Alternatively, the control unit 10 can acquire detection element information or model information about the camera 200 based on a user input performed via the input unit 8. Moreover, in the case of an exemplary embodiment in which a sensor for detecting the state of the image sensor 22 is provided in the confirmation unit 3, in step S202, the control unit 10 acquires the above-mentioned detection element information based on information about, for example, an image detected by the confirmation unit 3.

In step S203, the control unit 10 determines control information based on the detection element information about the image sensor 22 acquired in step S202. Specifically, the control unit 10 determines respective driving widths required for moving forward and backward the confirmation unit 3, the first cleaning unit 4, and the second cleaning unit 5 with use of the movable seat 6 based on information about the position and size of the image sensor 22, and controls respective distances to the detection surface. Moreover, the control unit 10 also determines, for example, the air blowing position and blowing intensity of the first cleaning unit 4, the range of wiping cleaning for the second cleaning unit 5, and the presence or absence of a solvent to be applied to a wiping tool. Here, in the present exemplary embodiment, the cleaning apparatus 100 prepares a plurality of cleaning courses which uses at least one of the first cleaning unit 4 and the second cleaning unit 5, and the user is allowed to select a cleaning course from among a plurality of candidates displayed on, for example, the display unit 7 in consideration of, for example, the state of dirt or the working time. The prepared courses include, for example, the following ones. In the following description, while, in the present exemplary embodiment, the subsequent flow is described on the assumption that a course 1 has been selected, in a case where another course is selected, a step or steps which are not needed for the selected course can be omitted (passed without any operation being performed) as appropriate. Moreover, the courses which are able to be set are not limited to these, but a course which is generated by the user freely setting various sequences can be provided.

Course 1: First confirmation sequence→First cleaning sequence→Second cleaning sequence→First cleaning sequence→Second confirmation sequence.
Course 2: First confirmation sequence→First cleaning sequence→Second cleaning sequence→Second confirmation sequence.
Course 3: First confirmation sequence→Second cleaning sequence→First cleaning sequence→Second confirmation sequence.
Course 4: First confirmation sequence→First cleaning sequence→Second confirmation sequence.
Course 5: First confirmation sequence→Second cleaning sequence→Second confirmation sequence.
Course 6: First confirmation sequence.

In step S204, to execute various sequences on the image sensor 22, the control unit 10 transmits signals for instructing the camera control unit 21 to move up the mirror 25 and fully open the shutter 26. The camera control unit 21, which has received the instruction signals for mirror up and shutter opening, moves up the mirror 25 and fully opens the shutter 26, and then transmits a signal indicating the completion of such operations to the control unit 10, and the control unit 10, which has received the transmitted signal, advances the processing to a next step. However, there are also models of cameras in which, even without step S204 being performed, the image sensor 22 is not shielded and is thus able to be subjected to cleaning, such as the above-mentioned mirrorless single-lens camera, and, in that case, step S204 and step S211, which is described below, are not needed.

In step S205, the control unit 10 performs the confirmation sequence illustrated in FIG. 4A as a first confirmation sequence, which is performed before cleaning is performed. In step S206, the control unit 10 performs a first cleaning sequence using the first cleaning unit 4, which is illustrated in FIG. 4B. After completion of the first cleaning sequence, in step S207, the control unit 10 performs a second cleaning sequence using the second cleaning unit 5, which is illustrated in FIG. 4C. Here, the reason why the first cleaning sequence is to be performed before the second cleaning sequence is because, in order to prevent the image sensor surface 30 from being damaged by large dust adhering to the image sensor surface 30 being dragged during wiping cleaning performed by the second cleaning unit 5, such large dust is to be removed beforehand in the first cleaning sequence.

After completion of the second cleaning sequence, in step S208, the control unit 10 re-performs the first cleaning sequence, which uses the first cleaning unit 4. Operations included in this sequence can be the same as or can be made different from those in step S206. Here, the reason why the first cleaning sequence is performed after the second cleaning sequence is because fibers of the wiping tool may remain on the image sensor surface 30 during wiping cleaning performed by the second cleaning unit 5 or dust pushed to outside the image sensor surface 30 may remain at the peripheral thereof. Performing the first cleaning sequence after the second cleaning sequence enables blowing off such pieces of dust to make the image sensor surface 30 clean.

After completion of the first cleaning sequence performed in step S208, then in step S209, the control unit 10 performs a second confirmation sequence, which is performed after cleaning, illustrated in FIG. 4A. The difference of the second confirmation sequence, which is performed after cleaning, from the first confirmation sequence, which is performed before cleaning, is that, in step S104, the control unit 10 is able to display, on the display unit 7, images captured before and after cleaning and states indicating, for example, the numbers of pieces of dust measured before and after cleaning in a comparable manner. In step S210, the control unit 10 determines whether the number of pieces of dust which is based on image information after cleaning acquired in step S209 is less than a predetermined value (falls below a predetermined value). If, in step S210, it is determined that the number of pieces of dust is not less than the predetermined value (NO in step S210), the processing returns to step S206, in which the control unit 10 re-performs cleaning. At this time, to remove dust which has not been able to be removed although being once subjected to each cleaning sequence, it is favorable that the control unit 10 changes various parameters for cleaning and then re-performs each cleaning sequence. For example, with regard to the first cleaning unit 4, the conceivable changes of parameters include, for example, making the intensity of air stronger than last time, making the degree of charging by an ionizer stronger than last time, making the blowing time longer than last time, and making the moving range wider than last time. Moreover, with regard to the second cleaning unit 5, the conceivable changes of parameters include, for example, applying a solvent to the wiping tool if no solvent has been applied thereto in the last cleaning and making the contact pressure on the image sensor surface 30 stronger than last time.

If, in step S210, it is determined that the number of pieces of dust is less than the predetermined value (YES in step S210), the processing proceeds to step S211, in which the control unit 10 transmits signals for instructing the camera control unit 21 to move down the mirror 25 and close the shutter 26. In step S211, the camera control unit 21, which has received the instruction signals for mirror down and shutter closing, moves down the mirror 25 and closes the shutter 26, and then transmits a signal indicating the completion of such operations to the control unit 10, and the control unit 10, which has received the transmitted signal, ends the cleaning process.

Here, while, in the present exemplary embodiment, to confirm the state of cleaning in step S210, the control unit 10 detects the number of pieces of dust remaining on the image sensor 22, the present exemplary embodiment is not limited to this, and another analysis result can be used as a basis as long as that indicates the state of the image sensor 22 which is analyzable from an image. Moreover, while, in the present exemplary embodiment, an example in which each cleaning sequence is repeatedly performed until the number of pieces of dust becomes less than the predetermined value has been described, the result of cleaning, such as the number of pieces of dust, only needs to be displayed on the display unit 7, and the repetitive flow does not necessarily need to be provided.

As described above, in the present exemplary embodiment, with respect to a detection surface of a detection element which detects a physical amount, after cleaning by the first cleaning unit 4, which performs cleaning with wind pressure (blowing), is performed, cleaning by the second cleaning unit 5, which performs wiping cleaning by contact, is performed. This enables appropriately removing a plurality of types of dust adhering to the detection surface. Additionally, re-performing non-contact cleaning after wiping cleaning enables removing fibers of the wiping tool or dust having failed to be removed during wiping cleaning or dust present at the periphery of the detection surface. Moreover, performing image capturing on the detection surface before or after cleaning or before and after cleaning to acquire an image or images of the detection surface enables confirming the state of the detection surface obtained before or after cleaning or before and after cleaning. At this time, when a point light source is used as the light source to illuminate the detection surface, since it is possible to acquire an image having a deeper depth of field and available for easily recognizing dust, it is easy to visually recognize or detect dust remaining on the detection surface. Moreover, analyzing an image obtained by performing image capturing on the detection surface enables analyzing the state of dust and making a display indicating the number of pieces of dust or a display for increasing the visibility of dust.

Additionally, providing a cleaning apparatus including a plurality of cleaning units which is able to perform a plurality of cleaning sequences enables coping with removal of a plurality of types of dust adhering to the detection surface of a detection apparatus including a detection element.

A configuration of the second cleaning unit 5 according to the present exemplary embodiment is described with reference to FIG. 8. FIG. 8 illustrates a configuration example of the second cleaning unit 5. A fiber tape 81, into which microfiber for wiping off dust is woven, a take-up portion 82, which is provided for taking up the fiber tape 81, a pay-out portion 83, which is provided for paying out the fiber tape 81, and a gear portion 84, which is provided for controlling the take-up amount, are mounted on a base plate 80. A fore-end core portion 86 made from metal is attached to the fore-end of a core material 85, and an elastic member 87 urges the core material 85 in the driving direction thereof. A vibrator 88 applies vibration to the fore-end core portion 86. A roller 89, which is a metallic component, is in contact with the core material 85 to define the driving direction of the core material 85. A guide member 90, which is a member for regulating the motion of the fiber tape 81, is molded with resin. The vibrator 88 applies minute vibration in the z-direction to the fore-end core portion 86 during a cleaning operation by generating vibration with a piezoelectric element or an actuator, thus reducing frictional force between the fiber tape 81 and the image sensor surface 30 to enable a smooth cleaning operation. Moreover, since the vibration of the vibrator 88 reduces frictional force between the fiber tape 81 and each of the guide member 90 and the fore-end core portion 86, it also becomes possible to perform smooth take-up during take-up of the fiber tape 81.

Here, details of the operation of the second cleaning unit 5 during cleaning are described. First, the gear portion 84 takes up the fiber tape 81 while engaging with the fiber tape 81 and pulls out an unused fiber tape 81 from the pay-out portion 83, so that the unused fiber tape 81 is used for cleaning at the fore-end core portion 86. The used fiber tape 81 is taken up onto the take-up portion 82. The fiber tape 81 is regulated in motion by the guide member 90, and is driven to be taken up while the fiber tape 81 remains hung at the fore-end core portion 86. When cleaning is started, the fiber tape 81 set up at the fore-end core portion 86 is pressed against the image sensor 22 so as to perform a wiping-off operation for dust. At this time, the core material 85 is able to perform a slide operation in the pressing direction (the z-direction in FIG. 8), so that cleaning is performed with appropriate pressing force while the elastic member 87 is compressed. Since appropriate pressing force is applied to the image sensor surface 30 by the elastic member 87, it becomes possible to remove dust without damaging the image sensor 22. Moreover, the metallic roller 89 is kept in contact with the core material 85 even during the wiping-off operation, so that a conductive state between the fixing unit 2 and the core material 85 is secured via the metallic roller 89. During the wiping-off operation, the vibrator 88, which is attached onto the core material 85, applies a vibration to the core material 85, thus reducing friction between the fiber tape 81 and the image sensor surface 30 pressed against each other, so that it becomes possible to perform smooth cleaning without the fiber tape 81 getting stuck with the image sensor surface 30.

Here, the reason why the fixing unit 2 and the core material 85 are made conductive with each other and the effect thereof are described. There is an instance that, if there is a potential difference between the second cleaning unit 5 and the image sensor surface 30 (the image sensor 22), dust which have once been removed may be attracted to the image sensor surface 30 by electrostatic force and adhere thereto again. In addition, there is also an instance that contact-type cleaning has a high removal capacity for dust but involves a reciprocating wiping-off operation and is, therefore, likely to allow static electricity to accumulate on the imaging surface. If static electricity is generated on the imaging surface, dust flying in the air may also be attracted to the imaging surface. Therefore, in the configuration of the present exemplary embodiment, the fixing unit 2 and the core material 85 are made conductive with each other in such a way as to have the same potential, in other words, the potential of the core material 85 is made equal to the potential of the fixing unit 2 (a conduction member), i.e., the potential of ground, thus eliminating any potential difference between the core material 85 and the image sensor 22, the potential of which is also equal to the potential of ground. With this, since a potential difference between the second cleaning unit 5 and the image sensor surface 30 is illimitably small, it is possible to prevent dust from being attracted to the image sensor surface 30.

Additionally, in the present exemplary embodiment, during cleaning by air performed by the first cleaning unit 4, air ionized by the ionizer is blown onto the image sensor surface 30. With this, since static electricity on the image sensor surface 30 is removed, it is possible to prevent the image sensor surface 30 from being electrically charged from any cause and becoming likely to attract dust, and, during later cleaning by the second cleaning unit 5, it is possible to prevent a potential difference from occurring between the image sensor surface 30 and the second cleaning unit 5.

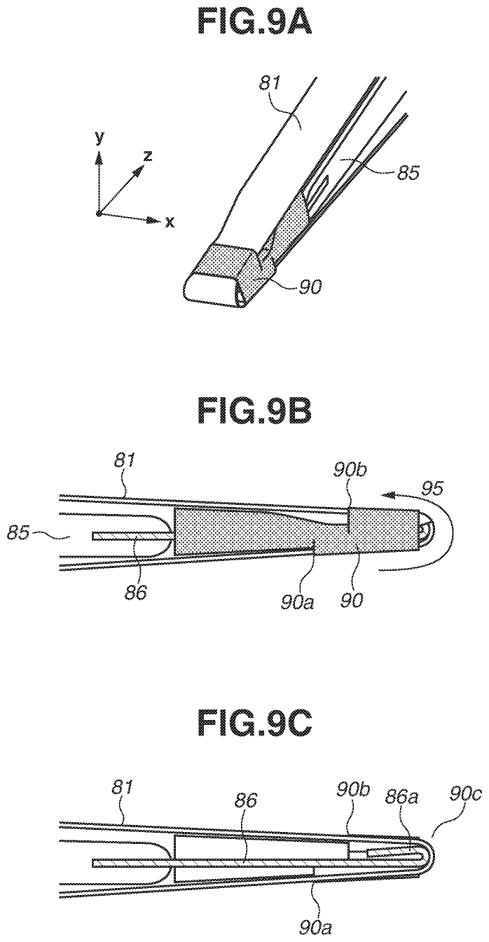

Next, a configuration of the fore-end region of the second cleaning unit 5, which is configured to come close to the image sensor surface 30, is described with reference to FIGS. 9A, 9B, and 9C. FIG. 9A is a perspective view illustrating details of the configuration of the fore-end region of the second cleaning unit 5, which is configured to come close to the image sensor surface 30. Moreover, FIGS. 9B and 9C are a side view and a sectional side view, respectively, as viewed from the lateral side. The motion of the fiber tape 81 is regulated with respect to the x- and y-directions by the guide member 90 and is regulated with respect to the z-direction by the fore-end core portion 86.

As illustrated in FIGS. 9B and 9C, the guide member 90 includes a pay-out port 90a and a take-up port 90b for the fiber tape 81, which are located opposite each other across the fore-end core portion 86. The pay-out port 90a for the fiber tape 81 is formed from an opening obtained by making a cut in the guide member 90. When the fiber tape 81 is taken up to be moved in the direction of arrow 95, the fiber tape 81 begins to be nipped between the guide member 90 and the fore-end core portion 86 from the pay-out port 90a, so that the motion of the fiber tape 81 in the x- and y-directions begins to be regulated.

The take-up port 90b for the fiber tape 81 is formed from an opening obtained by making a cut in the guide member 90. The fiber tape 81 is nipped between the guide member 90 and the fore-end core portion 86 in the range of an opening 90c at the for-end of the guide member 90 to the take-up port 90b, so that the motion of the fiber tape 81 in the x- and y-directions when the fiber tape 81 is taken up is regulated. The take-up port 90b is formed at a position nearer to the opening 90c than the pay-out port 90a. This enables regulating the motion of the fiber tape 81 in the x- and y-directions at a position closer to the image sensor surface 30 during cleaning.

The fore-end of the guide member 90 has one opening 90c, and is divided into two sides, i.e., the side of the pay-out port 90a and the side of the take-up port 90b, across the fore-end core portion 86. The fore-end core portion 86 is made by folding back a metallic plate, and a round (R) portion shape 86a of the folded portion is configured to face the image sensor 22 during cleaning. Employing a shape such as the R portion shape 86a enables preventing the fiber tape 81 from getting stuck with the end of the fore-end core portion 86 when being taken up to be moved. Moreover, with regard to the end opposite to the fixing end at which the fore-end core portion 86 is fixed to the core material 85, locating the fore-end of the folded portion of the fore-end core portion 86 on the side of the take-up port 90b also enables preventing the fiber tape 81 from getting stuck with the end of the fore-end core portion 86.

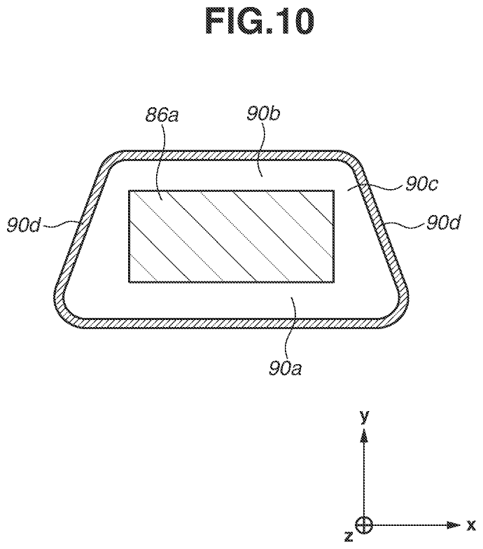

FIG. 10 is a view of the opening 90c as viewed from the z-direction, in which, for ease of explanation, the fiber tape 81 is omitted from illustration. As illustrated in FIG. 10, the shape of the opening 90c is formed by a continuous surface 90d in such a manner that the opening width of the opening 90c in the x-direction becomes gradually narrower as coming closer to the take-up port 90b from the pay-out port 90a. In particular, the dimension of the opening width in the x-direction on the side of the take-up port 90b is smaller than the width of the fiber tape 81 in the x-direction, and the dimension of the opening width in the x-direction on the side of the pay-out port 90a is larger than the width of the fiber tape 81 in the x-direction.

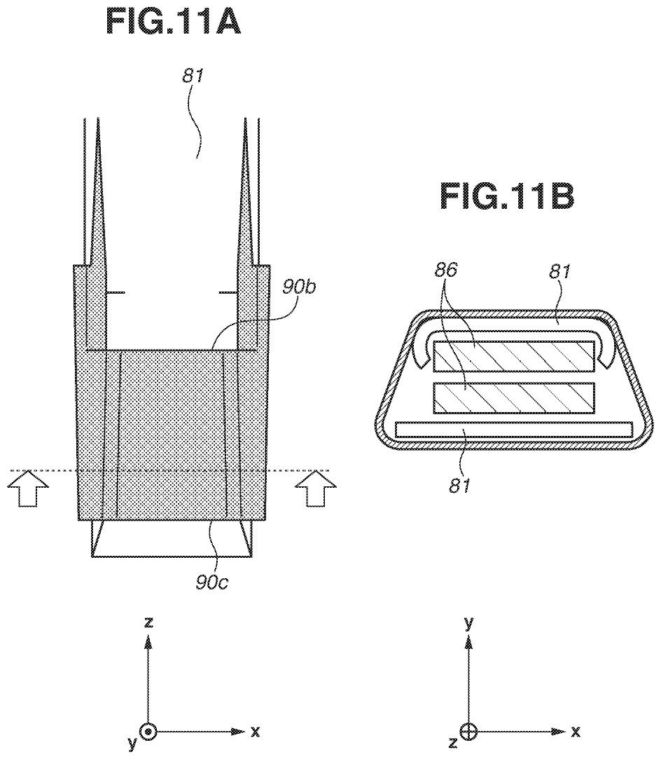

FIG. 11A is a view of the fore-end region of the second cleaning unit 5 as viewed from the side of the take-up port 90b. When, at the opening 90c, the fiber tape 81 enters the side of the take-up port 90b from the side of the pay-out port 90a, the dimension of the opening width in the x-direction on the side of the take-up port 90b is set smaller than the width of the fiber tape 81. Therefore, the fiber tape 81 enters the take-up port 90b while narrowing in such a form that the right and left ends (both ends) of the fiber tape 81 are bent and tucked toward the core material 85.

FIG. 11B is a sectional view of a dashed line portion illustrated in FIG. 11A as viewed from the direction indicated arrows in FIG. 11A. As illustrated in FIG. 11B, since the right and left ends of the fiber tape 81 are bent and tucked, when the fiber tape 81 is about to move in the x-direction, the trajectory of the fiber tape 81 is moved back to the center by repulsion force generated at the right and left ends. With this, when the image sensor surface 30 is cleaned by the second cleaning unit 5, the fiber tape 81 is prevented from shifting to one side in the x-direction, so that it is possible to perform cleaning while stabilizing the trajectory.

Moreover, since the fiber tape 81 is prevented or reduced from shifting to one side in the x-direction, it is possible to make the contact portion of the fiber tape 81 parallel to the image sensor surface 30. Additionally, since pressure is able to be evenly applied to the image sensor surface 30, it is possible to perform cleaning with less uneven wiping than in a case where the right and left ends are not bent and tucked.

Moreover, since the fiber tape 81 is gradually bent and tucked along the continuous surface 90d of the guide member 90, when, at the opening 90c, the fiber tape 81 enters the take-up port 90b from the pay-out port 90a, the fiber tape 81 is prevented from getting stuck with the guide member 90.

When the bent and tucked right and left ends of the fiber tape 81 exit from the take-up port 90b, the fiber tape 81 returns to its original flat shape without bent portions, and is then taken up onto the gear portion 84.

Moreover, as illustrated in FIG. 7A, the second cleaning unit 5 moves in such a way as to advance in the longitudinal direction of the image sensor 22 while bringing the fiber tape 81 into contact with the image sensor surface 30, thus wiping the surface of the image sensor 22. At this time, to make the cleaning apparatus 100 available for image sensors with various sizes, it is favorable that the width of the fiber tape 81 is equal to or less than the length in the shorter side direction of the effective pixel range of the smallest one of image sensors included in imaging apparatuses which are attachable to the cleaning apparatus 100.

On the other hand, to reduce a cleaning time, it is favorable that the range which is able to be wiped with one cleaning operation is wide. Therefore, it is favorable that the width of the fiber tape 81 is greater than a value obtained by dividing the dimension in the shorter side direction of the effective pixel range of the above-mentioned smallest image sensor by 3.

With this, it is possible to complete cleaning of the entire effective pixel range with the wiping-off operation performed at least three times with respect to each of the first cleaning area 42 and the second cleaning area 43 illustrated in FIG. 7A.

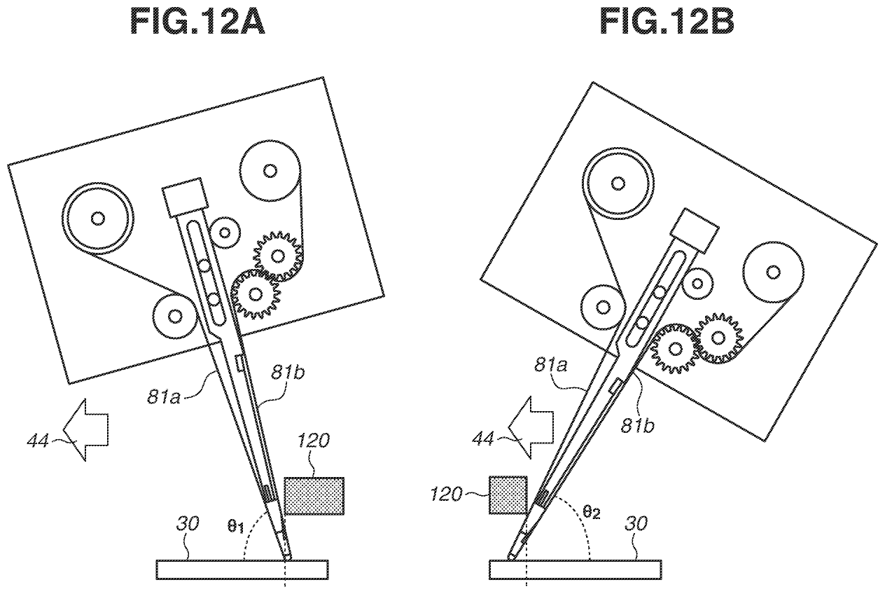

The contact angle of the second cleaning unit 5 during cleaning according to the present exemplary embodiment is described with reference to FIGS. 12A and 12B. FIG. 12A illustrates a case where the used surface 81b of the fiber tape 81 faces the image sensor surface 30, and FIG. 12B illustrates a case where the unused surface 81a of the fiber tape 81 faces the image sensor surface 30.

To clean the image sensor 22, the second cleaning unit 5 needs to clean only the whole surface of the image sensor 22 while avoiding an interior component 120, such as the mirror 25 or the shutter 26, mounted in the camera 200. Therefore, the second cleaning unit 5 inserts the fiber tape 81, which is suspended in a tensioned manner on the core material 85, into the camera 200, and performs cleaning while performing position control with use of the movable seat 6 based on an instruction from the control unit 10. At this time, when the used surface 81b of the fiber tape 81 comes close to the image sensor 22, the risk of dust which has once been removed dropping down and adhering to the image sensor 22 again increases. Therefore, as illustrated in FIG. 12A, in the case of performing cleaning at an angle according to which the used surface 81b faces the image sensor 22, the second cleaning unit 5 sets the angle θ1 large and performs cleaning while making the distance between the image sensor 22 and the used surface 81b as large as possible. On the other hand, as illustrated in FIG. 12B, in the case of performing cleaning at an angle according to which the unused surface 81a faces the image sensor 22, since the possibility of dust adhering to the image sensor 22 again is low, the second cleaning unit 5 sets the angle θ2 small and performs cleaning at an angle according to which the fore-end thereof is more unlikely to get stuck by friction. In this way, performing control in such a way as to become θ1>θ2 in consideration of the positional relationship between the fiber tape 81 and the image sensor 22 enables performing a wiping-off operation at an optimum contact angle while reducing the risk of dust adhering to the image sensor 22 again.

Moreover, it is favorable that the angle between the unused surface 81a and the used surface 81b is smaller than an angle obtained by subtracting the angle θ1 from 90 degrees. With such a configuration employed, in a case where the internal component 120, which is a part of the camera 200, is present on the subject side of the image sensor 22, inclining the second cleaning unit 5 by the angle θ1 or the angle θ2 enables the fiber tape 81 to get under the internal component 120 and then clean the image sensor surface 30.

As described above, in the present exemplary embodiment, the cleaning portion (the core material 85 and the fiber tape 81) of the second cleaning unit 5, which performs contact-type wiping cleaning, and the detection surface (the image sensor surface 30) are made equal to each other in potential, which is the potential of ground. This prevents attraction of dust to the detection surface, which occurs in a case where there is a potential difference between the cleaning portion and the detection surface.

Moreover, also performing static electricity removal processing by ionized air on the detection surface prevents the detection surface from being electrically charged to attract dust, even in consideration of only the detection element.

Here, the method of making the cleaning portion and the detection surface equal to each other in potential is not limited to the method mentioned in the above-described exemplary embodiment. For example, the method of making those equal to each other in potential includes making the image sensor surface 30 and the core material 85 directly conductive with each other at a portion different from the portion at which cleaning is performed.

Moreover, in the present exemplary embodiment, any deviation of the cleaning tape from the cleaning trajectory is prevented or reduced to reduce incomplete wiping by contriving a configuration of the cleaning portion (fore-end) at the fore-end of the second cleaning unit 5, which performs wiping cleaning. Specifically, making at least one of the following contrivances on a core material and a wiping tool, which is wound along the sides of the core material, enables attaining the above-described advantageous effect to no small extent:

Guides are provided at a pay-out portion and a take-up portion.

A core material made from metal is provided with a pay-out port at one side and a take-up port at the opposite side.

The take-up port is narrower than the tape width.

The pay-out port is wider than the take-up port.

The take-up port is formed integrally with the pay-out port by a continuous surface.

The take-up port exit is closer to the fore-end than the pay-out port entrance.

The core material is made by folding back a metallic plate and the folded-back end surface is formed on the side of the take-up port.

While, in the above description, an exemplary embodiment of the present disclosure has been described, the present disclosure is not limited to the above-described exemplary embodiment including the layout of apparatuses and the combination of sequences, but can be modified or altered in various manners within the scope of the gist thereof.

### Modification Example 1

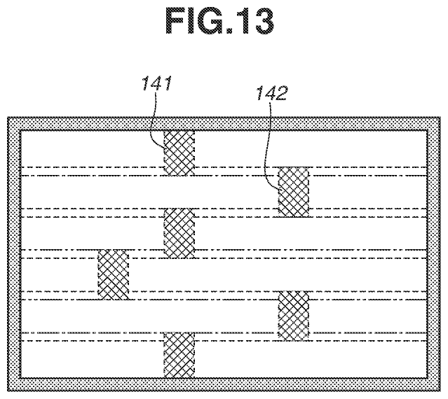

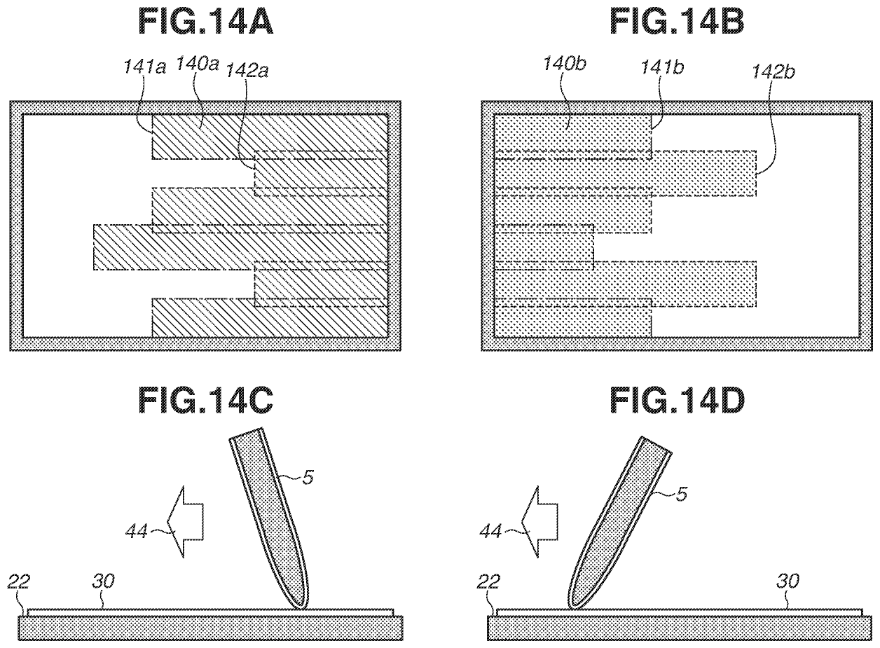

Next, another example of the cleaning method in step S121 in the second cleaning sequence is described with reference to FIG. 13 and FIGS. 14A, 14B, 14C, and 14D. Furthermore, for the sake of simplicity, portions similar to those in the above-described exemplary embodiment are omitted from description.

FIG. 13 and FIGS. 14A to 14D are imagery diagrams illustrating a cleaning method performed by the second cleaning unit 5 in step S121 in the present modification example. FIGS. 14A and 14B are views of the image sensor surface 30 of the image sensor 22 as viewed from the front side. FIGS. 14C and 14D are views of the image sensor surface 30 of the image sensor 22 as viewed from the lateral side, and illustrate a behavior in which the second cleaning unit 5 comes into contact with the image sensor surface 30 to wipe the image sensor surface 30 with a wiping tool provided at the fore-end of the second cleaning unit 5.

FIGS. 14A and 14B illustrate a first cleaning area 140a, a second cleaning area 140b, and partial movement trajectories 141a, 141b, 142a, and 142b through which the second cleaning unit 5 passes.

As illustrated in FIG. 14A, the ending point of the movement trajectory 141a and the ending point of the movement trajectory 142a are controlled to be at different positions with respect to the cleaning direction 44, thus being set at positions which are away from each other by a predetermined distance or more. Then, after cleaning in the first cleaning area 140a is completed, cleaning in the second cleaning area 140b is started. At this time, as illustrated in FIG. 14B, the cleaning starting points of the movement trajectories 141b and 142b are determined in such a manner that there are regions which overlap the respective movement trajectories of the first cleaning area 140a by respective predetermined amounts, and cleaning is then started.

In other words, the control unit 10 sets the position at which the second cleaning unit 5 has come into contact with the image sensor surface 30 as a starting position, moves the second cleaning unit 5 in a predetermined advancing direction, sets a range from the starting position to an ending position at which the second cleaning unit 5 moves away from the image sensor surface 30 as one movement trajectory, and moves the second cleaning unit 5 with a plurality of movement trajectories, thus cleaning the image sensor surface 30. At this time, the control unit 10 performs control in such a manner that, with respect to a plurality of movement trajectories, the starting positions or ending positions of the respective movement trajectories in the surface excluding the end portions of the image sensor surface 30 are away from each other by a predetermined distance or more.

Areas 141 and 142 illustrated in FIG. 13 are areas in which the respective movement trajectories of the first cleaning area 140a and the second cleaning area 140b overlap each other, and are also positions at which the second cleaning unit 5 moves away from the image sensor surface 30 and then comes into contact with the image sensor surface 30 again so as to switch the inclination of the second cleaning unit 5.

If, as illustrated in FIGS. 7A to 7C, control is performed in such a manner that, in the respective movement trajectories, the second cleaning unit 5 moves away from the image sensor surface 30 and then comes into contact with the image sensor surface 30 again at the same position with respect to the cleaning direction 44, slight wiping unevennesses, which would occur due to discontinuous operations, are aligned in a straight line and may become visible on a captured image.

However, controlling the movement trajectories of the second cleaning unit 5 as illustrated in FIG. 13 enables dispersing the positions of discontinuous operations on the respective movement trajectories and thus making the wiping unevennesses unlikely to be visible.

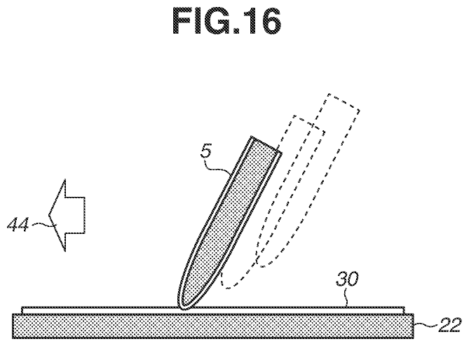

Moreover, as illustrated in FIG. 16, performing control in such a way as to bring the second cleaning unit 5 close to the image sensor surface 30 while moving the second cleaning unit 5 in the cleaning direction 44 also enables making the wiping unevennesses unlikely to be visible.

### Modification Example 2

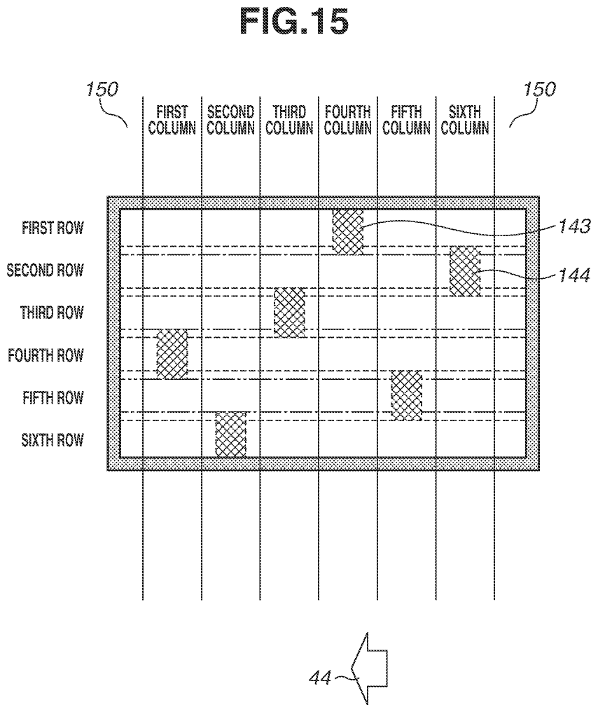

Additionally, a further example of the cleaning method in step S121 in the second cleaning sequence is described with reference to FIG. 15. Furthermore, for the sake of simplicity, portions similar to those in the above-described exemplary embodiment are omitted from description.

The difference between the modification example 1 and the modification example 2 lies in how to control regions in which the respective movement trajectories of the first cleaning area 140a and the second cleaning area 140b overlap each other or how to control positions at which the second cleaning unit 5 moves away from the image sensor surface 30 and then comes into contact with the image sensor surface 30 again so as to switch the inclination of the second cleaning unit 5.

As illustrated in FIG. 15, regions of the image sensor surface 30 are divided into regions in six rows with respect to a direction perpendicular to the cleaning direction 44 and into regions with same width in six columns with respect to a direction parallel to the cleaning direction 44, and positions at which to switch the inclination of the second cleaning unit 5 are controlled. At regions 150, switching of the inclination of the second cleaning unit 5 is restricted.

Areas 143 and 144 illustrated in FIG. 15 are areas in which the respective movement trajectories of the first cleaning area 140a and the second cleaning area 140b overlap each other, and are also positions at which the second cleaning unit 5 moves away from the image sensor surface 30 and then comes into contact with the image sensor surface 30 again so as to switch the inclination of the second cleaning unit 5. Here, switching of the inclination of the second cleaning unit 5 is limited to being performed only once in the same column. For example, as illustrated in FIG. 15, since, in the first row, switching of the inclination is performed in the fourth column, in the other rows, switching of the inclination is not performed in the fourth column.

Performing control in this way prevents positions of discontinuous operations from being aligned in the same column and enables making the wiping unevennesses unlikely to be visible.

Furthermore, control is performed in such a manner that switching of the inclination in a row is performed at a position at least two rows away from a position at which switching of the inclination is performed in an adjacent row. For example, as illustrated in FIG. 15, since switching is performed in the second row and the sixth column and in the fourth row and the first column, switching in the third row is controlled to be performed in the third column.

Performing control in this way prevents another switching position from being located in the vicinity of a switching position, and thus enables making the wiping unevennesses further unlikely to be visible.

Furthermore, while, in the modification example 2, control is performed with division into areas in six rows and six columns, the method for division is not limited to this.

### Modification Example 3

In FIGS. 12A and 12B in the above-described exemplary embodiment, in a state in which the fiber tape 81 is pressed against the image sensor surface 30 by the second cleaning unit 5, when the gear portion 84 takes up the fiber tape 81, tension is generated at the fiber tape 81, so that a force for causing the core material 85 to retract against the elastic force of the elastic member 87 acts. While, if the core material 85 retracts from the image sensor surface 30 in the process of cleaning, wiping unevenness occurs, if the gear portion 84 does not take up the fiber tape 81, the fiber tape 81 sags due to a force of friction with the image sensor surface 30, so that there is an instance that the used surface of the fiber tape 81 comes into contact with the image sensor surface 30 again.

Therefore, next, to cope with the above-mentioned instance, a modification example of the exemplary embodiment in which, even when the fiber tape 81 is taken up in the process of cleaning, wiping unevenness is unlikely to occur is described.

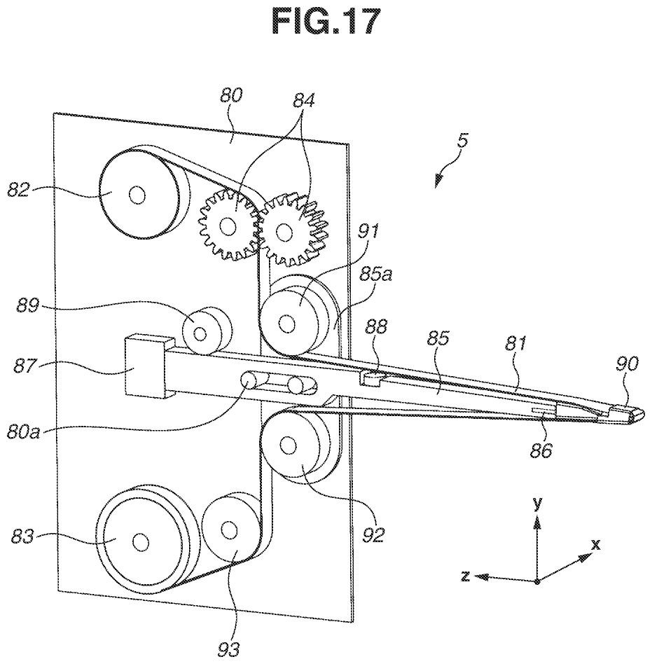

FIG. 17 is a schematic diagram illustrating only the second cleaning unit 5 in the modification example 3. Furthermore, for the sake of simplicity, only portions which need to be described in the modification example 3 are described.

A slide guide portion 80a is provided on the base plate 80 in an integrated manner therewith. A gear portion 84 is provided on the base plate 80 to minutely control the take-up amount of the fiber tape 81 while preventing slipping, and a roller supporting portion 85a is formed to be movable integrally with the core material 85. Roller components 91 and 92 rotate along the motion of the fiber tape 81 on the roller supporting portion 85a. A roller component 93 is provided on the base plate 80 to regulate the direction in which the fiber tape 81 advances toward a roller component 92 after being paid out from the pay-out portion 83.

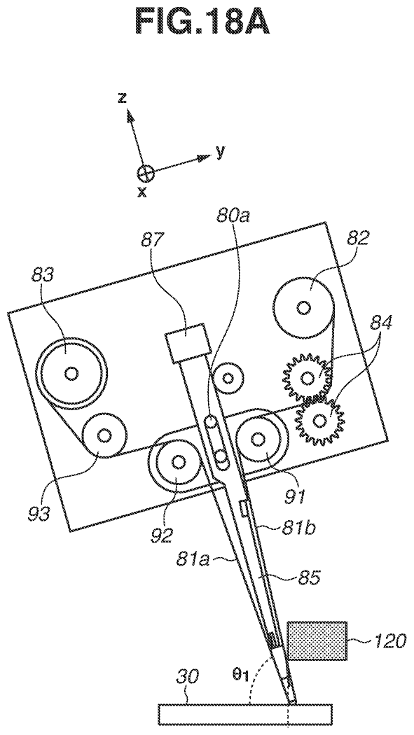

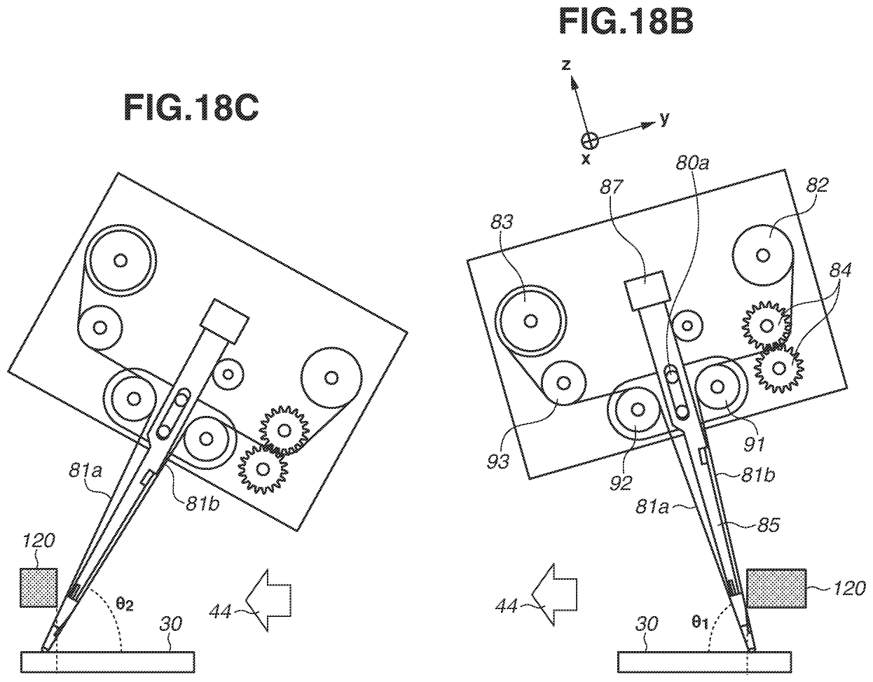

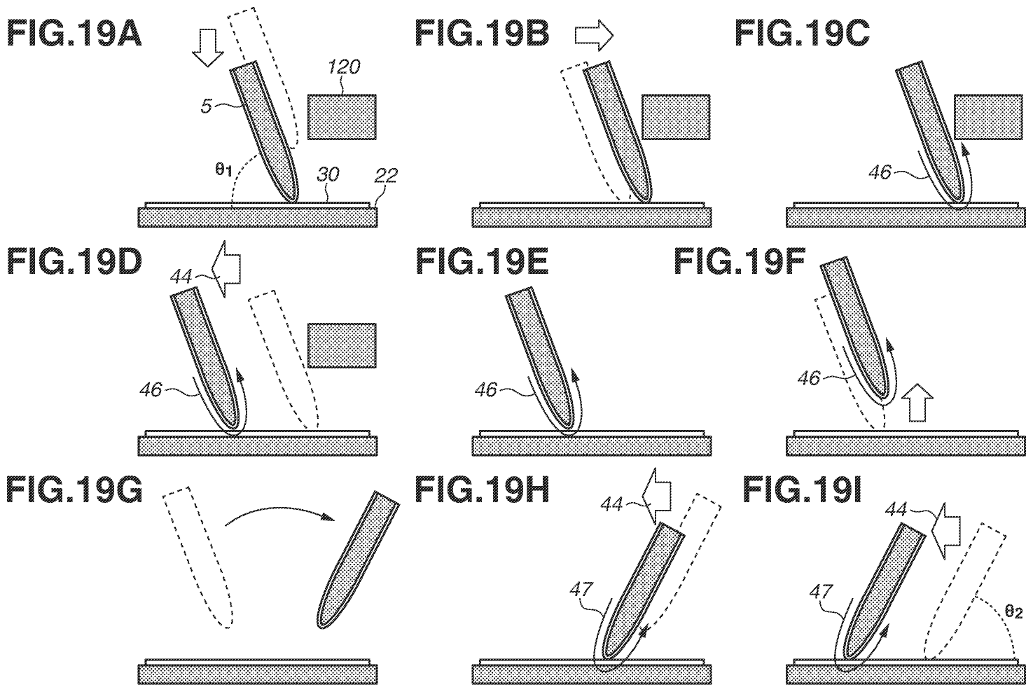

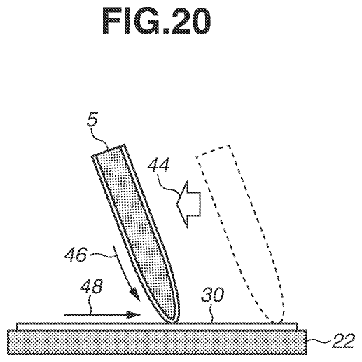

Next, details of an operation of the second cleaning unit 5 during cleaning according to the modification example 3 are described with reference to FIGS. 18A, 18B, and 18C and FIGS. 19A, 19B, 19C, 19D, 19E, 19F, 19G, 19H, and 19I.

FIG. 19A illustrates an operation in which the second cleaning unit 5 passes through the vicinity of the interior component 120 while avoiding collision therewith and comes into contact with and presses the image sensor surface 30. Furthermore, for the sake of simplicity, only a portion at which the second cleaning unit 5 comes into contact with the image sensor surface 30 is illustrated as an imaginary diagram as viewed from the lateral side.

FIG. 18A illustrates a state obtained when the fiber tape 81 has only come into contact with the image sensor surface 30 but before the fiber tape 81 is pressed against the image sensor surface 30 by the elastic force of the elastic member 87 via the core material 85. FIG. 18B illustrates a state in which the fiber tape 81 is being pressed against the image sensor surface 30 by the elastic force of the elastic member 87, which serves as a pressing mechanism. The movement direction of the second cleaning unit 5 is the same as the cleaning direction 44. In the state illustrated in FIG. 18A, the core material 85 is caused to collide with the slide guide portion 80a by the elastic force of the elastic member 87 and held by the slide guide portion 80a. At this time, the direction in which the fiber tape 81 is taken up from the roller component 91 (a regulating member) toward the gear portion 84 (a regulating member) is almost perpendicular to the z-direction, which is the direction in which the core material 85 is able to slide (pressing direction). Moreover, the direction in which the fiber tape 81 is taken up from the roller component 93 toward the roller component 92 is also almost perpendicular to the pressing direction.

Next, as illustrated in FIG. 18B, when the second cleaning unit 5 is controlled to come close to the image sensor surface 30 by a minute amount, the core material 85 slides and retracts in the z-direction illustrated in FIG. 18B from the state illustrated in FIG. 18A. Additionally, along with the motion of the core material 85, the roller component 91 and the roller component 92, which are mounted on the roller supporting portion 85a, also move by a minute amount. Then, the core material 85 becomes not held by the slide guide portion 80a, and the fiber tape 81 is pressed against the image sensor surface 30 by the elastic force of the elastic member 87 via the core material 85. Starting with this state, the second cleaning unit 5 performs cleaning on the image sensor surface 30.

FIG. 19B illustrates an operation in which, after the operation illustrated in FIG. 19A, the second cleaning unit 5 gets under the interior component 120 while being in contact with the image sensor surface 30 and then stops. At this time, the gear portion 84 does not take up the fiber tape 81, and the second cleaning unit 5 performs cleaning on the image sensor surface 30 while keeping the fiber tape 81 stopped.

Next, in FIG. 19C, the gear portion 84 starts to be driven and takes up the fiber tape 81. At that time, the fiber tape 81 moves on the second cleaning unit 5 in the direction indicated by arrow 46 and at a speed indicated thereby.

Next, as illustrated in FIG. 19D, the second cleaning unit 5 performs cleaning while moving on the image sensor surface 30 in the cleaning direction 44. At that time, the gear portion 84 takes up the fiber tape 81 in the direction indicated by arrow 46 and at a speed indicated thereby, so that an unused surface of the fiber tape 81 is always used to perform cleaning. At this time, as illustrated in FIG. 18B, a tension of the fiber tape 81 acting between the base plate 80 and the core material 85 is generated between the roller component 91 and the gear portion 84 and between the roller component 92 and the roller component 93, and the direction of the tension is approximately perpendicular to the z-direction, which is the sliding direction of the core material 85. Moreover, even when the outer diameter of the fiber tape 81 wound around each of the take-up portion 82 and the pay-out portion 83 varies as the fiber tape 81 continues being taken up, the gear portion 84 and the roller component 93 regulate the direction of the fiber tape 81, so that the above-mentioned direction of tension does not vary. Therefore, a force for moving the core material 85 toward the elastic member 87 by the tension of the fiber tape 81 is very small, so that, regardless of the state of the fiber tape 81 being taken up, it is possible to perform cleaning while pressing the core material 85 against the image sensor surface 30 with a constantly fixed pressing force. This enables reducing wiping unevenness in the process of cleaning.

FIG. 20 is a diagram illustrating the movement speed and direction of each member when the second cleaning unit 5 cleans the image sensor surface 30, and an arrow 48 indicates the movement speed and direction of the image sensor surface 30 relative to the second cleaning unit 5. As illustrated in FIG. 20, during a normal operation, the cleaning direction 44 is controlled in such a manner that the arrow 46, which indicates the take-up direction of the fiber tape 81, and the arrow 48, which indicates the movement direction of the image sensor surface 30 relative to the second cleaning unit 5, become the same direction at a contact point between the image sensor surface 30 and the fiber tape 81. Additionally, at that time, control is performed in such a manner that the movement speed of the second cleaning unit 5 relative to the image sensor surface 30, which is indicated by the arrow 48, is higher than the speed at which the fiber tape 81 moves on the second cleaning unit 5, which is indicated by the arrow 46. Performing control in this way enables performing cleaning in such a way as to drag the fiber tape 81 included in the second cleaning unit 5 on the image sensor surface 30, thus making dust on the image sensor surface 30 likely to be caught by the fiber tape 81. In the case of cleaning an image sensor 22 the frictional force of which is large during cleaning, controlling a difference between the movement speeds indicated by the arrow 46 and the arrow 48 to be smaller than in the normal operation enables reducing the influence of frictional resistance during cleaning.

Furthermore, in a case where, after the completion of a normal cleaning operation, in step S210 illustrated in FIG. 5, it is determined that cleaning is incomplete, the control unit 10 can change the cleaning direction. At that time, the control unit 10 drives the second cleaning unit 5 in the direction opposite to the cleaning direction 44 illustrated in FIG. 20. However, since the take-up direction of the fiber tape 81 is the same as in the normal cleaning operation, the arrow 46, which indicates the take-up direction of the fiber tape 81, and the arrow 48, which indicates the movement direction of the image sensor surface 30 relative to the second cleaning unit 5, become the respective opposite directions. Performing control in this way enables making the force of the fiber tape 81 for catching dust stronger than in the normal cleaning operation.

Next, as illustrated in FIG. 19E, the control unit 10 stops moving the second cleaning unit 5 in the cleaning direction 44 so as to switch the inclination of the second cleaning unit 5 with respect to the image sensor surface 30.

Next, as illustrated in FIG. 19F, the control unit 10 causes the second cleaning unit 5 to move away from the image sensor surface 30. As in the states illustrated in FIG. 19E to FIG. 19F, the gear portion 84 continues being driven, so that, when the fiber tape 81 moves away from the image sensor surface 30, control is performed in such a manner that an unused surface of the fiber tape 81 continues being supplied. Performing control in this way enables preventing dust captured at the moment when the second cleaning unit 5 has stopped moving in the cleaning direction 44 from remaining on the image sensor surface 30 when the second cleaning unit 5 moves away from the image sensor surface 30. After the second cleaning unit 5 moves away from the image sensor surface 30, the gear portion 84 stops being driven, thus interrupting take-up of the fiber tape 81.

Next, as illustrated in FIG. 19G, the control unit 10 performs a switching operation for the inclination of the second cleaning unit 5, and, then, as illustrated in FIG. 19H, the control unit 10 drives the gear portion 84 in the second cleaning unit 5 and resumes the motion of the fiber tape 81 in the direction indicated by arrow 47 and at the speed indicated thereby. At this time, the second cleaning unit 5 is controlled to come close to the image sensor surface 30 while moving in the cleaning direction 44.

As illustrated in FIG. 19I, the second cleaning unit 5 presses the image sensor surface 30 again and then performs cleaning while remaining inclined in the direction opposite to the cleaning direction 44.

At this time, performing control in such a manner that the movement speed of the fiber tape 81 indicated by the arrow 47 is higher than that indicated by the arrow 46 reduces a friction between the fiber tape 81 and the image sensor surface 30, and is thus more suited for cleaning.

As described above, in the configuration of the modification example 3, since the control unit 10 drives the gear portion 84 even in the process of the wiping-off operation and performs cleaning on the image sensor surface 30 while causing the gear portion 84 to take up the fiber tape 81, it is possible to prevent such a situation that the fiber tape 81 sags due to a frictional force and the used surface of the fiber tape 81 comes into contact with the image sensor surface 30 again.

The present disclosure can also be attained by performing the following process. Specifically, the process supplies a storage medium on which program code of software with procedures for implementing the functions of the above-described exemplary embodiments described therein has been recorded to a system or apparatus. Then, the process causes a computer (or a CPU or a micro processing unit (MPU)) of the system or apparatus to read out and execute the program code stored in the storage medium.

In this case, the program code itself read out from the storage medium implements novel functions of the present disclosure, and a storage medium and a program with the program code stored therein can constitute the present disclosure.

Moreover, the storage medium used to supply the program code includes, for example, a flexible disk, a hard disk, an optical disk, and a magneto-optical disk. Moreover, storage medium used to supply the program code further includes, for example, a compact disc read-only memory (CD-ROM), a compact disc recordable (CD-R), a compact disc rewritable (CD-RW), a digital versatile disc read-only memory (DVD-ROM), a digital versatile disc random access memory (DVD-RAM), a digital versatile disc rewritable (DVD-RW), a digital versatile disc recordable (DVD-R), a magnetic tape, a non-volatile memory card, and a read-only memory (ROM).

Moreover, making the program code read out by the computer executable implements the functions of the above-described exemplary embodiments. Additionally, for example, an operating system (OS) running on the computer can also perform a part or the whole of the actual processing based on an instruction from the program code so as to implement the functions of the above-described exemplary embodiments.

Furthermore, the following process can be included. First, the process writes the program code read out from the storage medium into a memory included in a function expansion board inserted into the computer or a function expansion unit connected to the computer. After that, for example, a CPU included in the function expansion board or function expansion unit performs a part or the whole of the actual processing based on an instruction from the program code.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2018-142899, filed Jul. 30, 2018, and No. 2019-092467, filed May 15, 2019, which are hereby incorporated by reference herein in their entirety.

What is claimed is:

1. A cleaning apparatus which cleans a detection element having a detection surface, the cleaning apparatus comprising:
a wiping cleaner configured to perform wiping cleaning in a state of being in contact with the detection surface; and
a conduction member configured to become conductive with the wiping cleaner to be made equal in electric potential to the wiping cleaner,
wherein, when the wiping cleaner and the conduction member become conductive with each other, the detection surface and the wiping cleaner become equal in electric potential to each other.

2. The cleaning apparatus according to claim 1, wherein the conduction member is connected to ground.

3. The cleaning apparatus according to claim 1, further comprising:
an air cleaning unit configured to clean the detection surface with wind pressure of air,
wherein the air cleaning unit removes static electricity of the detection surface by blowing ionized air to the detection surface.

4. A cleaning apparatus which cleans a detection element having a detection surface, the cleaning apparatus comprising:
a wiping tool configured to clean the detection surface while being in contact with the detection surface;
a take-up mechanism configured to take up the wiping tool;
a core material configured to fold back the wiping tool in a take-up direction and bring a folded-back portion of the wiping tool into contact with the detection surface; and
a guide member configured to regulate motion of the wiping tool at the folded-back portion of the wiping tool,
wherein the guide member includes a take-up port on a take-up side with respect to the core material, and an opening width of the take-up port of the guide member is formed to be narrower than a width of the wiping tool.

5. The cleaning apparatus according to claim 4, wherein the guide member includes a pay-out port on a side opposite to the take-up port across the core material, and an opening width of the pay-out port is formed to be wider than the width of the wiping tool.

6. The cleaning apparatus according to claim 4, wherein the pay-out port and the take-up port of the guide member are formed integrally with each other.

7. The cleaning apparatus according to claim 4, wherein, when the wiping tool is taken up by the take-up mechanism, both sides of the wiping tool are deformed in a direction toward the core material along a direction in which the wiping tool is taken up at the take-up port.

8. A cleaning apparatus which cleans a detection element having a detection surface, the cleaning apparatus comprising:
a wiping cleaner configured to perform wiping cleaning in a state of being in contact with the detection surface;
one or more processors; and
a memory storing instructions which, when executed by the one or more processors, cause the cleaning apparatus to function as:
a control unit configured to control cleaning performed by the wiping cleaner by switching between the wiping cleaner coming into contact with the detection surface and the wiping cleaner moving away from the detection surface and controlling movement of the wiping cleaner,
wherein the control unit sets a position at which the wiping cleaner has come into contact with the detection surface as a starting position, moves the wiping cleaner, sets a range from the starting position to an ending position at which the wiping cleaner moves away from the detection surface as one movement trajectory, cleans the detection surface with a plurality of movement trajectories, and controls cleaning performed by the wiping cleaner in such a manner that, with respect to the plurality of movement trajectories, the starting positions or ending positions of the respective movement trajectories in the detection surface excluding end portions of the detection surface are away from each other by a predetermined distance or more.

9. The cleaning apparatus according to claim 8, wherein the control unit controls cleaning performed by the wiping cleaner in such a manner that, with respect to the plurality of movement trajectories, the starting positions or ending positions of the movement trajectories having the same advancing direction are away from each other by the predetermined distance or more.

10. The cleaning apparatus according to claim 8, wherein the control unit causes the wiping cleaner to perform the wiping cleaning by causing a cleaning portion of the wiping cleaner including a core material and a wiping tool for performing cleaning to come into contact with the detection surface in a state of being inclined relative to the detection surface and moving the cleaning portion.

11. A control method for a cleaning apparatus which cleans a detection element having a detection surface, the control method comprising:
causing a wiping cleaner configured to perform wiping cleaning in a state of being in contact with the detection surface to switch between the wiping cleaner coming into contact with the detection surface and the wiping cleaner moving away from the detection surface and to move to perform the wiping cleaning,
wherein, in the wiping cleaning, a position at which the wiping cleaner has come into contact with the detection surface is set as a starting position, the wiping cleaner is moved, a range from the starting position to an ending position at which the wiping cleaner moves away from the detection surface is set as one movement trajectory, the detection surface is cleaned with a plurality of movement trajectories, and cleaning performed by the wiping cleaner is controlled in such a manner that, with respect to the plurality of movement trajectories, the starting positions or ending positions of the respective movement trajectories in the detection surface excluding end portions of the detection surface are away from each other by a predetermined distance or more.

12. The cleaning apparatus according to claim 4, further comprising:
a pressing mechanism configured to press the core material to the detection surface;
at least one first regulating member formed to be driven in a pressing direction in an integrated manner with the core material; and
at least one second regulating member located opposite to the first regulating member with respect to the folded-back portion of the wiping tool,
wherein an advancing direction of the wiping tool is configured to be able to be changed by the first regulating member and the second regulating member in such a way as to differ in angle from the pressing direction for the core material.

13. The cleaning apparatus according to claim 12, wherein the advancing direction of the wiping tool changed by the first regulating member and the second regulating member is approximately perpendicular to a movement direction of the core material.

14. The cleaning apparatus according to claim 12, wherein the at least one first regulating member is located on a side closer to the take-up mechanism than the folded-back portion of the wiping tool.

15. The cleaning apparatus according to claim 12, wherein the at least one first regulating member and the at least one second regulating member respectively include one first regulating member and one second regulating member which are located across the folded-back portion of the wiping tool.

16. The cleaning apparatus according to claim 12, wherein the wiping tool is taken up by the take-up mechanism while the wiping tool is in contact with the detection surface.

17. The cleaning apparatus according to claim 16, wherein a take-up direction for the wiping tool is identical with a movement direction of the detection surface relative to the core material during wiping cleaning.

18. The cleaning apparatus according to claim 16, wherein a movement speed of the detection surface relative to the core material during wiping cleaning is higher than a take-up speed for the wiping tool.
